(19) United States
(12) Patent Application Publication
(10) Pub. No.: US 2003/0140043 A1
(43) Pub. Date: Jul. 24, 2003

(54) Clinical research data management system and method

(75) Inventors: Robert N. Hotchkiss, Riverside, CT (US); Thomas W. Bloomfield, Derry, NH (US); Brent Gendleman, Washington, DC (US); Paul Duvall, Annandale, VA (US); Kevin Puscas, Germantown, MD (US); Greg Gurley, Cabin John, MD (US); Rob Daly, Washington, DC (US)

Correspondence Address: ALLEN BLOOM, C/O DECHERT, PRINCETON PIKE CORPORATION CENTER, P.O. BOX 5218, PRINCETON, NJ, 08543-5218, US

(73) Assignee: New York Society for the Relief of the Ruptured & Cripple Maintaining the HOSP for Special Surgery, New York, NY (US)

(21) Appl. No.: 10/055,675

(22) Filed: Jan. 23, 2002

(51) Int. Cl. G06F 7/00

(52) U.S. Cl. 707/10

(57) ABSTRACT

The invention is directed to a clinical research data management system and method for a plurality of disparate users. The system includes a presentation creation mechanism operable to provide users with data from a database, an application control and navigation mechanism operable to service user requests and a data access mechanism operable to access information that resides in the database. The database is operable to store user data and study data. The study data includes candidate data, specimen data, event data and at least one dataset. The dataset is defined using metadata. The database is operable to store at least one roll associated with each user. User access to study data, candidate data, specimen data, event data and/or data sets is individually limited based on the at least one role associated with each user.

The present invention relates generally to the field of scientific data management and more particularly to data management systems and methods for facilitating clinical research.

The invention seeks to provide geographically disparate medical professionals with specialized views of patient-related data. For example, lab technicians, clinicians, and genomic researchers may wish to examine some of the same information regarding an individual, but each may have particular interests as well. To complicate matters, certain data is often large and expensive to replicate and/or move from its natural home. To this end, a data network such as the Internet and associated communication platforms provide the basis for greater collaboration between doctors and laboratory scientists, a means to connect a patient or subject to a larger quantity of relevant data and potentially influence the workflow and results of Medicine, from diagnosis to treatment.

The system preferably incorporates one or more of the following features:

Role Based Authentication and Authorization: wherein users have defined roles and capabilities commensurate associated with that role. For example a user may have access limited to specific studies, events, data sets and questions as discussed in more detail below.

Secured System Messaging: wherein communication between users is restricted or otherwise limited based on the rights of the users.

Secured Data Access: wherein a user's access to data (e.g., read/write privileges) is restricted or otherwise limited based on the user's rights. A user's access to a particular item of data is regulated by the user's role in connection with either a dataset definition encompassing the data item in question or the individual data item definition. The system can also include audit trails including information relating data access (e.g., who, what, when . . . ).

Further Study Controls: wherein the association between data records, patients and specimens are carefully tracked so that accurate follow-up work can be performed.

Structured Flexibility: wherein users are provided with a mechanism for organizing unpredictable or unexpected information.

Data Storage Using MetaData: wherein the system database utilizes metadata for maximum data storage flexibility so that modification of the database structure is not likely required for implementation of a broad range of study requirements.

### SUMMARY OF THE INVENTION

The invention relates to a clinical research data management system and method for a plurality of users. A computer system is operable to service user requests and provide users with information responsive to the user requests. A database is coupled to the computer system. The database is operable to store user data and study data. The study data includes candidate data, specimen data, event data and at least one dataset. The dataset is defined using metadata.

In a preferred aspect of the invention, the database is operable to store data related to scheduled events and unscheduled events.

In another preferred aspect of the invention, the computer system is operable to send and receive electronic messages between at least two users.

In another preferred aspect of the invention, the computer system is operable to limit communication of electronic messages between user having a specific role in connection with a specific study.

In another preferred aspect of the invention, the candidate data includes data relating to a plurality of candidates and the specimen data includes data relating to a plurality of specimens wherein the system is operable to associate each specimen with a candidate.

In another preferred aspect of the invention, the user data includes at least one role associated with each user.

In another preferred aspect of the invention, the roles includes a data monitor, enroller, data editor, study administrator and system administrator.

In another preferred aspect of the invention, the role defines data access rights granted at the dataset definition level.

In another preferred aspect of the invention, the role defines data access rights granted at the data item definition level.

In another preferred aspect of the invention, the role defines data access rights granted at the dataset definition level and the data item definition level.

In another preferred aspect of the invention, the database is operable to identify at least a portion of the user data as privacy data, wherein the role defines a users ability to view privacy data.

In another preferred aspect of the invention, the database includes at least one display form associated with the dataset, wherein the display form is defined using metadata.

In another preferred aspect of the invention, the database includes at least two display forms associated with the dataset, wherein the display forms are defined using metadata.

In another preferred aspect of the invention, a first display form is formatted to render the dataset on a first display device, and a second display form is formatted to render the dataset on a second display device.

In another preferred aspect of the invention, a first display form is formatted to render the dataset in a first language, and a second display form is formatted to render the dataset in a second language. It is understood that the invention encompasses system and methods having many dataset each having one or more display forms.

In another preferred aspect of the invention, the database stores an audit record of data access including information relating to the data accessed, user, date and time.

One technical effect of the invention is a flexible database structure that facilitates the study definition process for a broad range of studies.

Another technical effect of the invention is a role based authentication and authorization mechanism that provides a simple, flexible and secure mechanism for coordinating user data access.

Another technical effect of the invention is secured system messaging that provides a mechanism to restrict or otherwise limit electronic communication between users based on the rights of the users (e.g., based on the roles assigned to the users).

Another technical effect of the invention is an audit trail mechanism for collecting including information relating data access (e.g., who, what, when . . . ). These and other technical effects are readily apparent from the disclosure herein.

### BRIEF DESCRIPTION OF THE DRAWINGS

FIG. 1 is an block diagram of an exemplary system having a client tier, a middle tier and a data tier in accordance with the invention.

FIG. 2 is a block diagram showing several application elements including a presentation creation mechanism, a data access mechanism application control and navigation mechanisms and application and data security mechanisms in accordance with the invention.

FIG. 3 is a pictorial diagram showing exemplary roles and an associated level of data access, including Data Monitor, Enroller, Data Editor, Study Administrator and System Administrator roles in accordance with the invention.

FIG. 4 is a pictorial diagram showing the organization of the design model broken into logical layers, each representing a collection of packages, subsystems and classes that are related by the responsibilities they have within the operations of the system in accordance with the invention.

FIG. 5 is a pictorial diagram showing exemplary elements of the system architecture including presentation layer, application layer, data access object, value objects and utility elements in accordance with the invention.

FIG. 6 is a pictorial diagram showing a graphical representation of the mechanisms and elements involved in processing request generated from a client web browser in accordance with the invention.

FIG. 7 is a pictorial diagram showing exemplary login functions in accordance with the invention.

FIG. 8 is a pictorial diagram showing exemplary study home page in accordance with the invention.

FIG. 9 is a pictorial diagram showing exemplary register candidate subject functions in accordance with the invention.

FIG. 10 is a pictorial diagram showing an exemplary register specimen function in accordance with the invention.

FIG. 11 is a pictorial diagram showing advanced search features in accordance with the invention.

FIG. 12 is a pictorial diagram showing exemplary open enrolment functions in accordance with the invention.

FIG. 13 is a pictorial diagram showing exemplary close enrolment functions in accordance with the invention.

FIGS. 14a and 14b are pictorial diagrams showing an exemplary role definition function in accordance with the invention.

FIGS. 15a and 15b are pictorial diagrams showing an exemplary role assignment function in accordance with the invention.

FIGS. 16a and 16b are pictorial diagrams showing exemplary user administration functions in accordance with the invention.

FIG. 17 is a pictorial diagram showing exemplary subject enrollment functions in accordance with the invention.

FIG. 18 is a pictorial diagram showing exemplary add/edit study data functions in accordance with the invention.

FIG. 19 is a pictorial diagram showing exemplary add/edit genetics data functions in accordance with the invention.

FIG. 20 is a pictorial diagram showing exemplary review data functions in accordance with the invention.

FIG. 21 is a pictorial diagram showing exemplary approve data set functions in accordance with the invention.

FIG. 22 is a pictorial diagram showing exemplary approve (freeze) data set functions in accordance with the invention.

FIG. 23 is a pictorial diagram showing an exemplary reinstate function in accordance with the invention.

FIG. 24 is a pictorial diagram showing an exemplary mail message center screen in accordance with the invention.

FIG. 25 shows an exemplary mail message in accordance with the invention.

FIG. 26 shows an exemplary listing of scheduled events in accordance with the invention.

FIG. 27 shows an exemplary detailed view of a particular subject listing both scheduled and unscheduled events in accordance with the invention.

FIG. 28 shows an exemplary data input screen for entering an unscheduled event in accordance with the invention.

FIG. 29 shows an exemplary confirmation message after adding an unscheduled event in accordance with the invention.

FIG. 30 shows an exemplary detailed view of a particular subject listing both scheduled and unscheduled events including a newly added unscheduled event in accordance with the invention.

FIGS. 31a and 31b show exemplary database tables in accordance with the invention.

### DETAILED DESCRIPTION OF THE INVENTION

The following terms shall have, for the purposes of this application, the respective meanings set forth below:

Client: generally refers to a computer system or process that requests a service of another computer system or process (e.g., a “server”) using some kind of protocol and accepts the server's responses. A client is part of a client-server software architecture.

Database: generally refers to a collection of information stored for later retrieval. Traditional databases are organized by fields, records, and files. A field is a single piece of information; a record is one complete set of fields; and a file is a collection of records. The term “database” is used herein in its broadest sense (i.e., a collection of information) and is not limited to any particular structure or implementation.

Data network: generally refers to a group of two or more computer systems linked together in data communication. The term “data network” encompasses any type of wired or wireless computer network, independent of protocol, including local-area networks (LANs), wide-area networks (WANs) and networks of networks including the an intranet, extranet and the Internet.

HTML: generally stands for “Hyper-Text Markup Language”, the authoring language used to create documents on the World Wide Web. HTML defines the structure and layout of a Web document by using a variety of tags and attributes.

Metadata: generally refers to the storage of data using a first set of database tables for storing the data definition and a second set of tables for storing the actual data. This is in contrast storing data in fixed set of tables with fixed attributes.

Rational Rose: generally refers to a model-driven software development tool utilizing UML.

Relational Database: A database generally built on a relationship model in which data is organized in tables. The set of names of the table columns is called the “schema” of the table. Data can be manipulated using a relational algebra. SQL is a standard language for communicating with and/or querying a database built on the relational model.

Server: generally refers to a program running on a computer that provides some service to other (e.g., client) programs. The connection between client and server is normally by means of message passing, often over a network, and uses some protocol to encode the client's requests and the server's responses.

SQL: generally refers to “structured query language”, a standardized query language for requesting information from a database.

UML: generally refers to Unified Modeling Language, a method for specifying, visualizing, and documenting the artifacts of an object-oriented system under development.

System Architecture

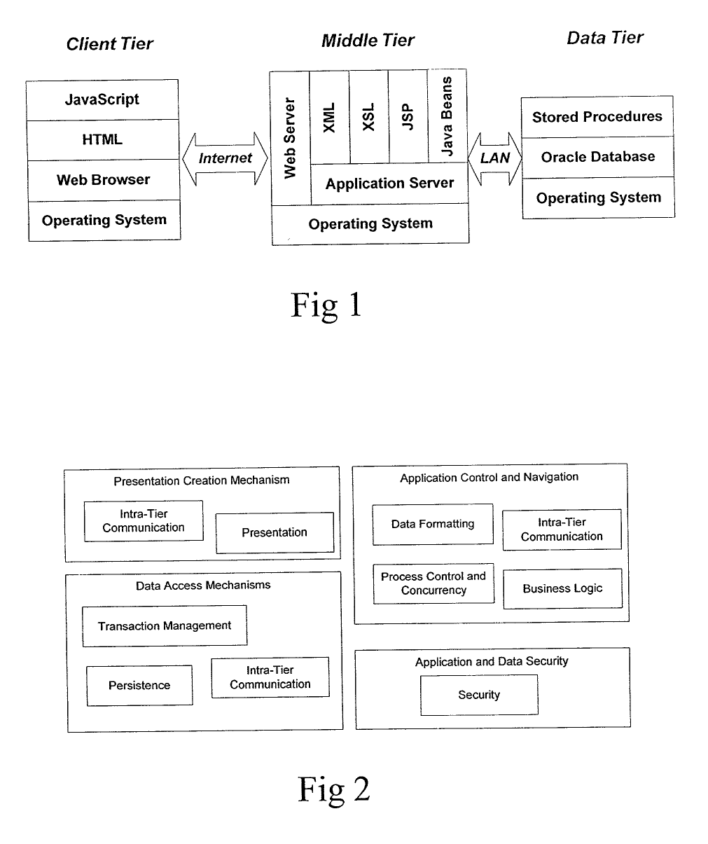

The invention is preferably designed as a multi-tiered web application. An exemplary block diagram is shown in FIG. 1. The client tier is preferably composed of presentation and presentation logic elements that provide user access and interaction. The middle tier preferably handles application control, business logic and data access. The data tier preferably provides application data utilizing various enterprise resources including database management systems (e.g. a relational database management system or RDBMS).

The user preferably accesses the application using a web browser (e.g., Microsoft® Internet Explorer 5.0+). The web interface provides a graphical user interface by which the user can access the functionality of invention via a network processing device such as a personal computer or the like (e.g., desktop/laptop computer, PDA, wireless devices and the like).

In FIG. 1, arrows labeled with the terms “Internet” and “Lan” are exemplary data networking methods for interconnecting the functional blocks. Based on the disclosure herein, communication between the client tier, middle tier and data tier in accordance with the invention based on typical data networking principals is well within the grasp of those skilled in the art. It is also understood that data communication between the various tiers can traverse several nodes and/or can be facilitated one or more computer systems not shown.

Client requests are preferably handled by the middle-ware infrastructure. This infrastructure is responsible for interpreting the user's actions and performing the necessary processes. These processes include requested business processes (logic) and any information resource interactions. Exemplary middle-ware infrastructure can be based on the J2EE framework. This provides services such as presentation, communication, distribution, concurrency, and transaction management. Other exemplary technologies and the architectural mechanisms they support are shown in the table below.

TABLE 1

| Mechanism | Implementation Technologies |
|---|---|
| Presentation | HTML, JavaScript, Internet Explorer 5.0+ |
| | JavaServer Pages (JSP), eXtensible Markup |
| | Language (XML), eXtensible Style |
| | Language (XSL) |
| Intra-Tier Communication | HTTP for client to business tiers. TCP/IP |
| | for all others. |
| | XML internally between business and |
| | presentation layers. |
| Transaction Management | J2EE, Oracle |
| Security | Secure Sockets Layer (SSL HTTPS) |
| | Web Server and Application Server Security |
| | Mechanisms |
| | Custom role/rule based security |
| Process Control and | J2EE |
| Concurrency | |
| Business Logic | J2EE |
| Persistence | Oracle |
| Data Formatting | XML (with future consideration of HL7 |
| | interfacing) |

Architectural Mechanism Design

Each of the implementation technology mechanisms used in the invention are utilized by high-level mechanism designs. Each of these designs provides for the key application elements of data retrieval, presentation, security and business logic application. FIG. 2 illustrates this concept.

Presentation Creation

The presentation creation mechanism preferably provides the ability to provide highly dynamic information to the user. This is accomplished by the use of various presentation technologies. These mechanisms utilize other mechanisms that exist in the Process Control and Concurrency and Data Access mechanisms. This framework provides for the retrieval of data based on business logic, conversion of that data into appropriate formats and the integration of the data with the web presentation elements. This integration is preferably accomplished using a combination of JavaServer Pages, XML and XSL to create custom presentation elements that are displayed to the user. The use of these technologies also allows the presentation elements to be customized to not only the user but also the display device the user is using.

Application Control and Navigation

The application control and navigation mechanisms preferably provide for the implementation or servicing of user requests. This includes mechanisms for applying business logic to the request including managing user navigation through the software application. In addition the application control and navigation mechanisms handle the management of multiple users, checking security rules, and formatting the responses to the request in a manner appropriate for use by the presentation creation mechanisms. This is preferably handled through the use of Java Servlets, JavaBeans, and XML.

Data Access

The data access mechanisms are preferably designed to access the information that resides in the system. They preferably utilize the transaction management and persistence mechanisms to provide reliable and fault tolerant access to data. In addition they manage the security rules as defined to the accessing of data. The data access mechanism also provides for the uploading and retrieval of data from remote sites that are participating in a study. The data access mechanisms preferably use a combination of JavaBeans, JDBC, and Oracle stored procedures. In addition the data access mechanisms utilize a meta-model approach to allow definitions of data. This provides for a highly extensible and flexible data access capabilities.

Application and Data Security

The application and data security mechanism preferably relies on a number of different technologies and domain specific rules. The primary mechanism for managing security is the assignment of defined roles and the security rules applied to those roles. These rules include not only accessing parts of the application but also activities the user can perform within the system. In addition these rules define what individual pieces of data a user can access and the nature of that access. A user's access to a particular item of data is regulated by the user's role in connection with either a dataset definition encompassing the data item in question or the individual data item definition. In most cases it is sufficient to assign data access permissions to a role at the dataset definition level, but when fine-grained access is necessary, the role can be granted read/write access on the data item (field) level. When there is a conflict between the access rights between the dataset and data item level, the access granted on the data item level takes precedence, or overrides the access on the dataset level. This ensures that only properly designated users can access certain data.

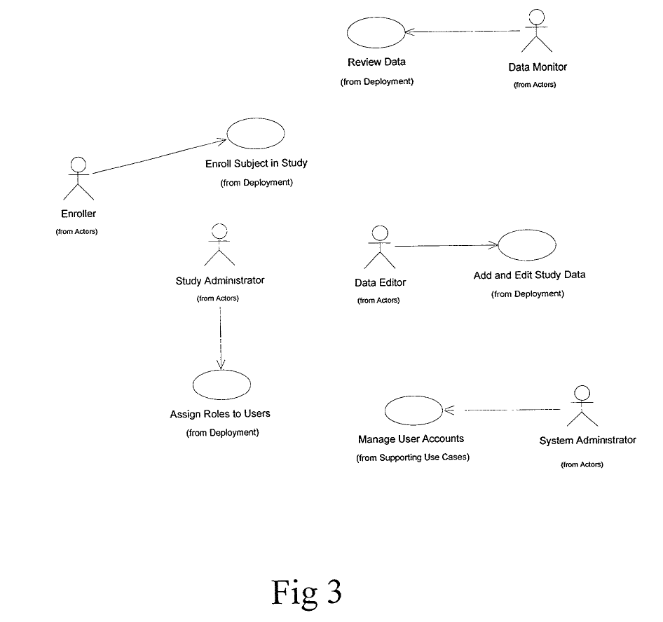

FIG. 3 shows exemplary roles and an associated level of data access. For example, a “Data Monitor” role entitles a user to review certain data (i.e., read only access). An “Enroller” role entitles a user to enroll subjects into a study. A “Data Editor” role entitles a user to review, add and edit certain data (i.e., read/write/modify access). The “Study Administrator” role entitles a user to assign roles to users. The “Systems Administrator” role entitles a user to manage user's access to the system for specified roles. It also provides the ability to disable or enable an individual's access to the system. This rules/roles based approach (discussed in more detail below) is preferably implemented using JavaBeans and Oracle stored procedures. Other security aspects depend upon various web based security mechanisms (i.e. SSL) and J2EE security specifications.

Review Data

The Review data use case is initiated by the Data Monitor and allows viewing of a study's data set. Portions of this data set are either local or remote. Based on access privileges (defined by role), certain data fields can be viewed.

Assign Roles to Users

The Assign Roles to Users use case is initiated by the Study Administrator and permits the assignment of roles with associated access privileges to particular data sets or elements within those sets. It also allows the administrator to change the defined access for roles. It is assumed that 1) the users are already created, and 2) the roles have already been defined.

Add and Edit Study Data

The Add and Edit Study Data use case is initiated by a Data Editor or Patient (e.g. for study questionnaires), this use case allows adding or editing of data to a data set for a given study-subject pair based on security roles and access privileges. This use case allows for maintaining various types of clinical and research data sets (x-ray images, genotype files/images, clinical data, etc.). Access to data sets and data items (fields) are defined by roles assigned to each Data Editor. For example, a clinical Data Editor may have add/edit access to all data items of a subject, whereas, due to privacy act requirements, a genomic Data Editor will have read-only access to certain subject (when human) data items (sex, height, blood type, etc.). The various data editors preferably have rights to modify data with their domain only. For example, a genomic Data Editor can add/edit the genomic data set, but only view a portion of the clinical data set.

Enroll Subject in Study

The Enroll Subject in Study use case is initiated by the Enroller. This use case enrolls a subject into a study. The subject must have previously been registered as a candidate subject.

Manage User Accounts

The Manage User accounts use case is initiated by the System Administrator. This use case manages individuals' access to the system for specified roles. It also provides the ability to disable or enable an individual's access to the system.

Assign Roles to Users

The Assign Roles to Users use case is initiated by the Study Administrator. This use case manages individuals' access to the system for specified roles. It also provides the addition/removal of roles to/from individuals and the ability to disable or enable an individual's access to the system.

Logical View

The logical view of the system architecture describes the most important classes, their organization in service packages and subsystems, and the organization of these subsystems into layers.

Rational Unified Process uses the “Logical View in Rose” to organize the Design Model and the Process View and the optional Business Object Model and Analysis Model.

Architecture Overview—Package and Subsystem Layering

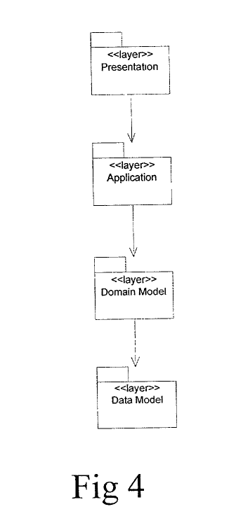

FIG. 4 shows the organization of the design model into logical layers. Each layer represents a collection of packages, subsystems and classes that are related by the responsibilities they have within the operations of the system.

The presentation layer consists of the mechanisms and classes used to create the presentation to the user. This includes classes for rendering presentation elements and controlling application navigation. The application layer consists of the study independent subsystems and subsystem interfaces that provide services for the system. These include data access and business logic. The domain model layer consists of the interfaces and classes that are used to perform all create, read, update, and delete operations on data. The data model represents the structure of the data tables as it exists in the database.

Architecturally-Significant Model Elements

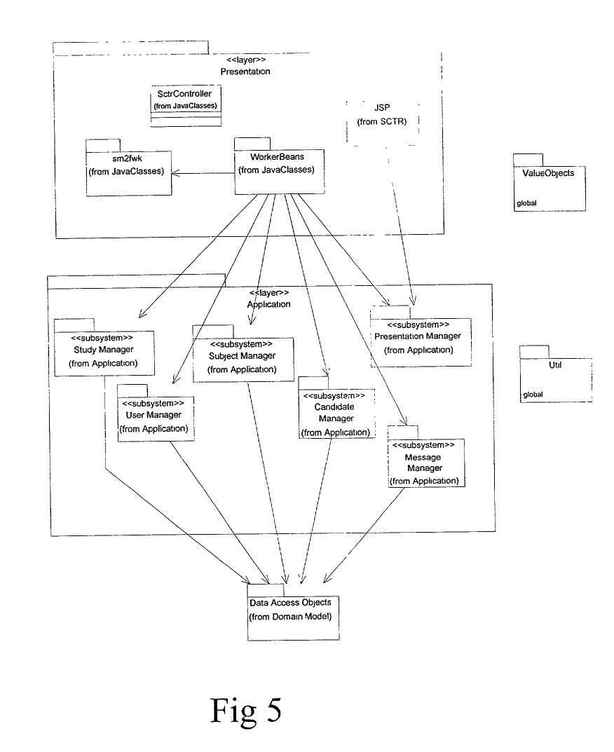

FIG. 5 shows exemplary elements of the system architecture.

SctrController—the primary controller for the receipt of user request and the dispatching of responses to those request.

Application—study independent subsystems and subsystem interfaces that provide services for the system. these include data access and business logic.

Presentation—mechanisms and classes used to create the presentation to the user. This includes classes for rendering presentation elements and controlling application navigation

WorkerBeans—JavaBeans used for handling user request processing.

Study Manager—provides services for study data related activities.

Subject Manager—provides services for study subject data related activities.

Candidate Manager—provides services for candidate data related activities.

Presentation Manager—provides services the manipulation of data for use by presentation devices.

sm2Fwk—provides the mechanisms and base classes of the Java Servlet based navigation system.

User Manager—provides services for user related activities.

Data Access Objects—classes used for the access of data contained in the database.

ValueObjects—classes that represent the domain model of the system. This includes the classes used for the data meta-model and the XML representation of all system data.

Util—general utilities used by different application classes.

Message Manager—provides communications services to the users.

JSP (Java Server Pages)—used for creating the graphical web presentation of data to the user.

Request Processing Overview

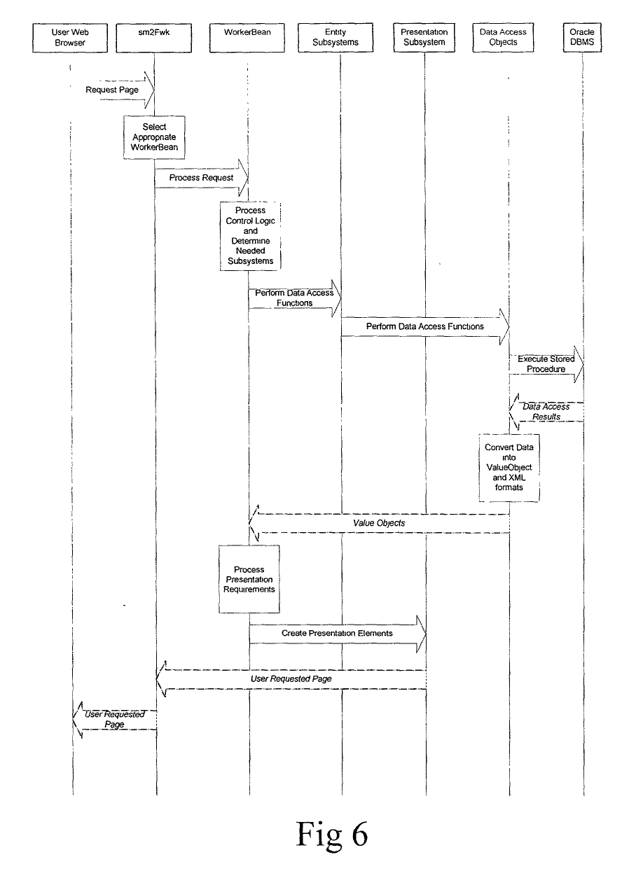

FIG. 6 represents an overview of the mechanisms and elements involved in processing request generated from a client web browser. These request are usually in the form of performing some action on or requesting data from the system. In the diagram solid arrows represent request made from one element to another. Boxes on an element line represent internal processing done by the element. DASHed arrows represent data returned from one element to another.

When a user requests a page from the system, the request is passed to the sm2Fwk subsystem and the appropriate WorkerBean is selected. The WorkerBean processes the control logic and determines which subsystems are needed. For example, various entity subsystem perform data access functions, data access objects retrieve data from the database and convert the data into value object and XML formats. The WorkerBean processes presentation requirements and creates presentation elements via the presentation subsystems. The user requested page is then delivered to the user via the sm2Fwk subsystem.

Security Architecture

As discussed above, they system incorporates security to limit what individual pieces of data a user can access and the nature of that access. This ensures that only properly designated users can access certain data. For example: only valid users will be able to access the system, only authorized users will be able to perform actions, all privacy data will be encrypted in the database, configurable security policies will be available to authorized users.

Authentication

Authentication is essentially the process of verifying that a user is properly authorized to use the system. The system preferably uses a combination of username/password authentication, 128-bit encryption, and the implementation of network security. The System Administrator is preferably the only role with the capability to add a user into the system.

Secure Sockets Layer

All data on web pages throughout the system is preferably encrypted using the 128-bit Secure Sockets Layer (SSL) protocol. SSL can be implemented on top of HTTP (Hypertext Transfer Protocol); also known as HTTPS. SSL uses public/private key encryption and the implementation of digital certificates. The system preferably uses server-side digital certificates only.

Username/Password

A user will be validated on the system by providing a valid username and password at the main web page that is validated against the database. This information is preferably encrypted across the network to prevent unauthorized individuals from capturing any of this sensitive information.

General Security Issues

The database (e.g., Oracle database) is preferably only be accessible by one IP Address. This IP Address is preferably that of the application server (e.g., WebLogic). Preferably, WebLogic resides on the only server that can access data in the database. Machines hosting system application servers are preferably hosted behind Firewall equipment. Configuration of Firewall hardware and software in connection with the system based on the disclosure herein is well within the scope of those skilled in the art. Configuration of appropriate Intranet security (DMZ, TCP Ports, Subnet domains, Virtual LAN and the like) in connection with the system based on the disclosure herein is also well within the scope of those skilled in the art.

Authorization

Authorization is the process of ensuring that once a user has been authenticated on the system, that the user only has the ability to perform actions and access data that they have been authorized to perform or to view based on the permissions designated by the Study Administrator.

Roles

A Study Administrator will be responsible for creating a role for a specific study. A role consists of a collection of capabilities and dataset permissions. The Study Administrator may create the role name and the associated capabilities and data permissions that is appropriate. Once a Role has been created within a study, the Study Administrator may then assign the Role to one or more users. Exemplary role definition and assignment functions are discussed in detail below.

Datasets

A dataset is designated as a group of data. A Study Administrator may setup a role to be given permission to specific datasets; such as add/edit/delete or read privileges. When a role is assigned to a user, this user will be given, or not given, this level of access to the datasets specified by the Study Administrator in the role.

Capabilities

A capability maps to a functional portion of the system. It may be a menu item, such as “Enroll Study”, or it may be a group of data, such as “View Privacy Data”. Once a user is assigned one or more roles within a study, the user receives access to all of the collective capabilities to the system for the roles that have been assigned to that user. See table 2 below for exemplary roles and associated functions:

TABLE 2

| Role | Function |
|---|---|
| System Administration | Backup Database |
| | Create Study |
| Study Administration | Deploy Study |
| | Close Study |
| | Open Enrollment |
| | Close Enrollment |
| | Define Business Rules |
| Enrollment | Enroll Subject |
| | Disenroll Subject |
| | View Enrollee |
| | Export Enrollee List |
| | Close Enrollment |
| User Administration | Create User Profile |
| | Disable User Profile |
| | Assign Role |
| | Disable Role |
| | Export Collaborator List |
| | Delete User |
| Dataset Administration | Approve Dataset |
| | Retract Approval |
| | View Data |
| | Edit Dataset |
| | Add Dataset |
| | Suspend Edit Capabilities |
| | Reinstate Edit Capabilities |
| | Export Dataset |

Table 2 generally defines an exemplary grouping of capabilities to be associated with exemplary roles. It is understood that these and/or other roles can be associated with a different set of capabilities.

Exemplary System Functions

Login Function

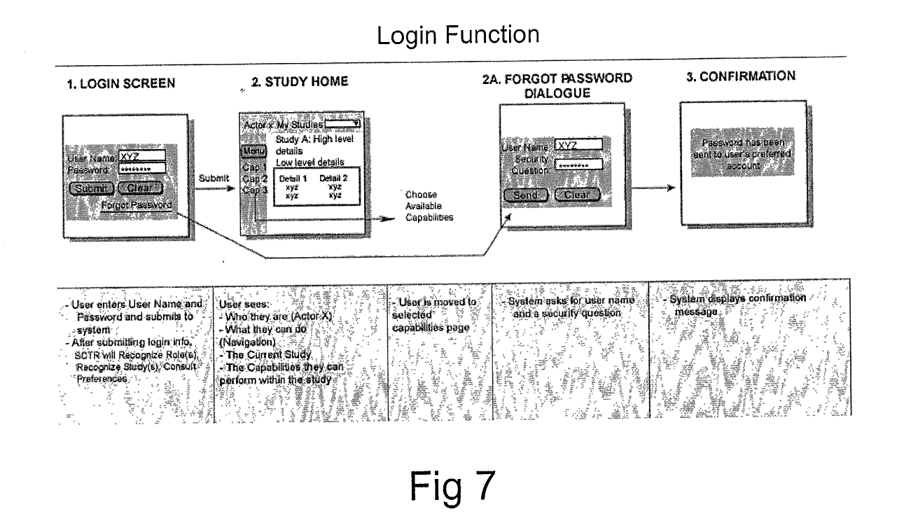

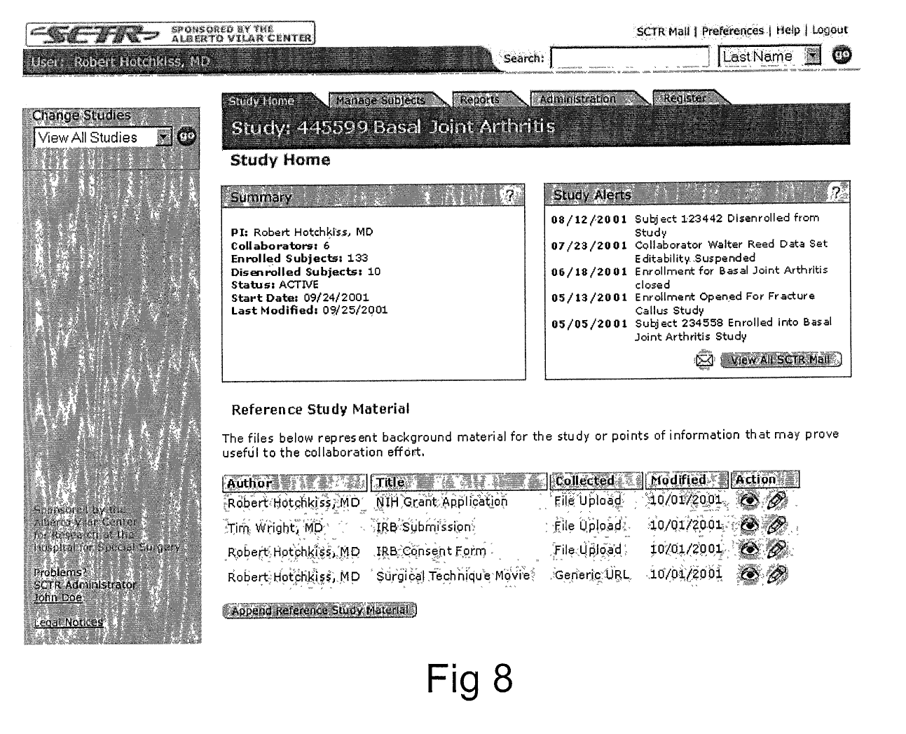

FIG. 7 shows exemplary login functions in accordance with the invention. The user accesses the system via a network processing device and web browser as discussed above. The user is then presented with a login screen, which prompts for a user name and password. The system receives the user name and password and compares them to previously stored values. Assuming the user name and password are valid, the user is permitted to access the system. Preferably, the user is then presented with a summary screen identifying the user (actor), what they can do (navigation), the current study and the user's capabilities within the study. If the user has forgotten their password, the system preferably provides a mechanism for granting access to the system (e.g., a security question must be answered correctly before access is granted).

Once the user is logged in, many functions will relate to a particular study. FIG. 8 shows an exemplary study home page. The study home page provides a basic interface so that the user perform study related tasks such as management of study subject, reports, administration and registration as discussed in more detail below

Registrar Function—Register Candidate

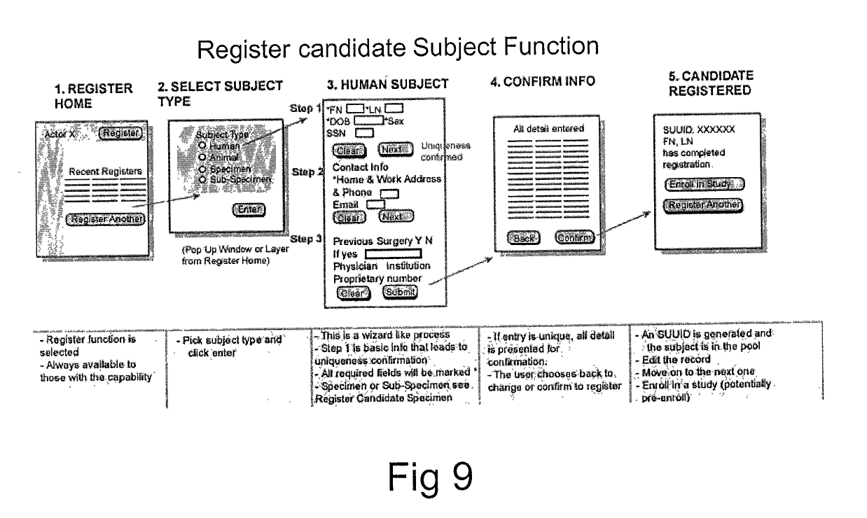

FIG. 9 shows exemplary register candidate subject functions in accordance with the invention. In order to access this function, the user must login to the system and must have the appropriate role and associated rights to act as a registrar. The register function is selected and candidate data or information is entered into the system. Candidate data includes: subject type (in this case a human), personal information (e.g., first name, last name, date of birth, social security number, contact information, medical history and the like). Once the information is entered into the system, the Registrar is presented with a confirmation screen. Assuming all of the candidate data is correct, the Registrar clicks the confirm button and the candidate data is stored in the system database. The system preferably identifies all required data fields and requires data entry in these fields before storing the candidate data, thereby registering the candidate (for later enrollment in a study).

Registrar Function—Register Specimen

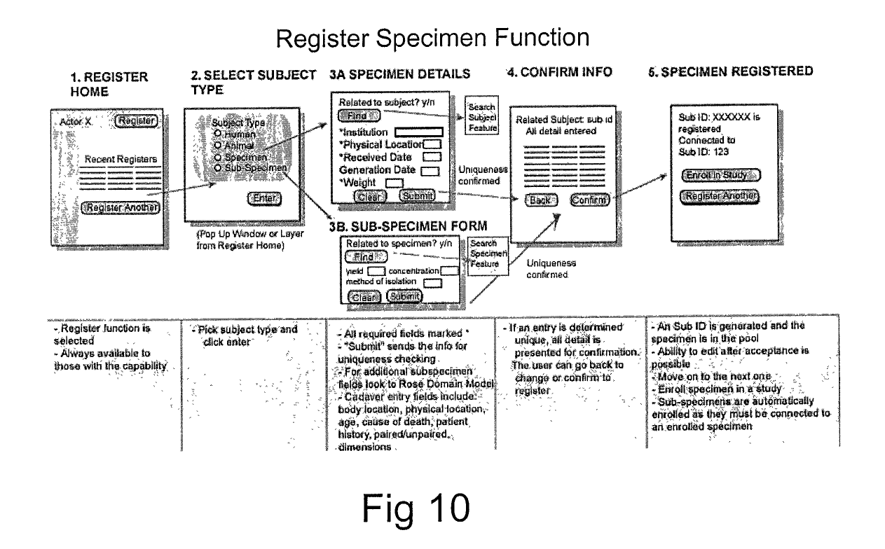

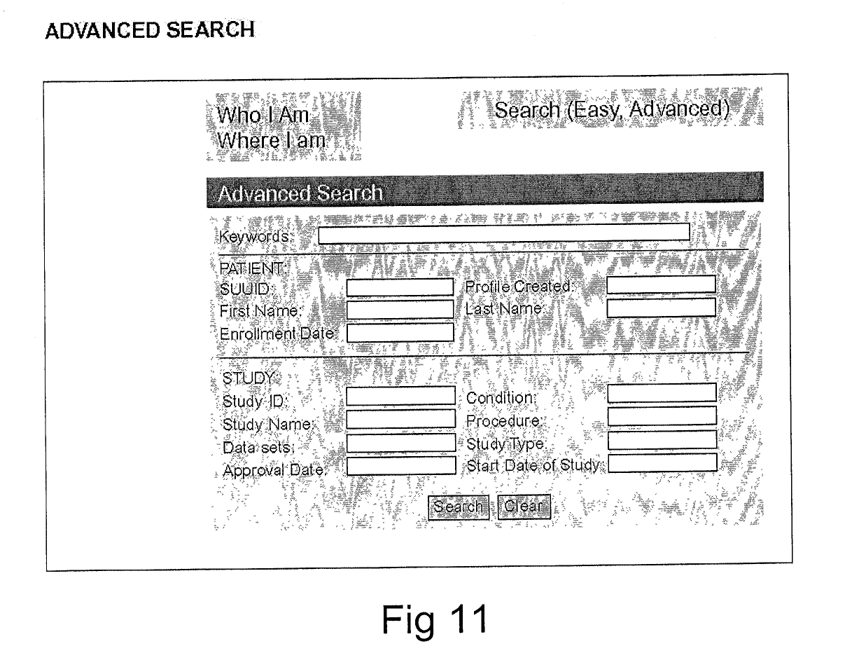

FIG. 10 shows an exemplary register specimen function in accordance with the invention. As discussed above, the register function is selected and specimen data or information is entered into the system. Specimen data includes: subject type (in this case a specimen), related subject, related specimen, institution, physical location, received date, generation date, weight and the like. The system preferably provides a search function to facilitate identification of related subjects and/or specimens. An exemplary search screen is shown in FIG. 11. Preferably, a search of data or information stored in the system can be performed based on key words, candidate or patient data, study data and the like. Once the information is entered into the system, the Registrar is presented with a confirmation screen. Assuming all of the specimen data is correct, the Registrar clicks the confirm button and the specimen data is stored in the system database. The system preferably identifies all required data fields and requires data entry in these fields before storing the candidate data, thereby registering the specimen.

Study Administrator Function—Open Enrollment

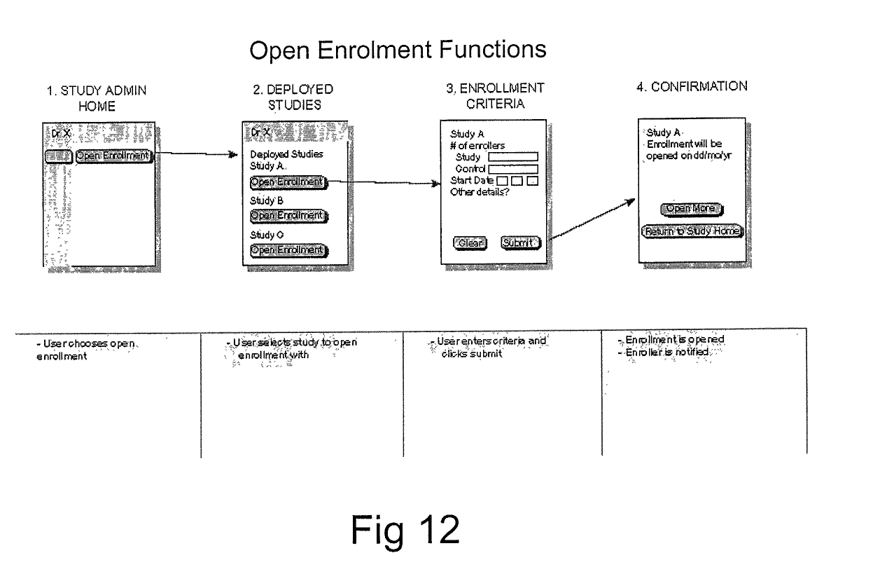

FIG. 12 shows exemplary open enrolment functions in accordance with the invention. In order to access this function, the user must login to the system and must have the appropriate role and associated rights to act as a Study Administrator. It is understood that one or more studies must be previously defined and entered into the system (having enrolment closed) before enrolment can be opened. The open enrollment function is selected and the appropriate study (for which enrollment will be opened) is then identified. The Study Administrator is prompted to enter enrollment data (information or criteria), such as the number of Enrollers, control information, start date and the like. Once the enrollment data is entered into the system, the Study Administrator is presented with a confirmation screen. Assuming all of the enrollment data is correct, the Study Administrator clicks the confirm button and the enrollment data is stored in the system database. The system preferably identifies all required data fields and requires data entry in these fields before storing the enrollment data.

Study Administrator Function—Close Enrollment

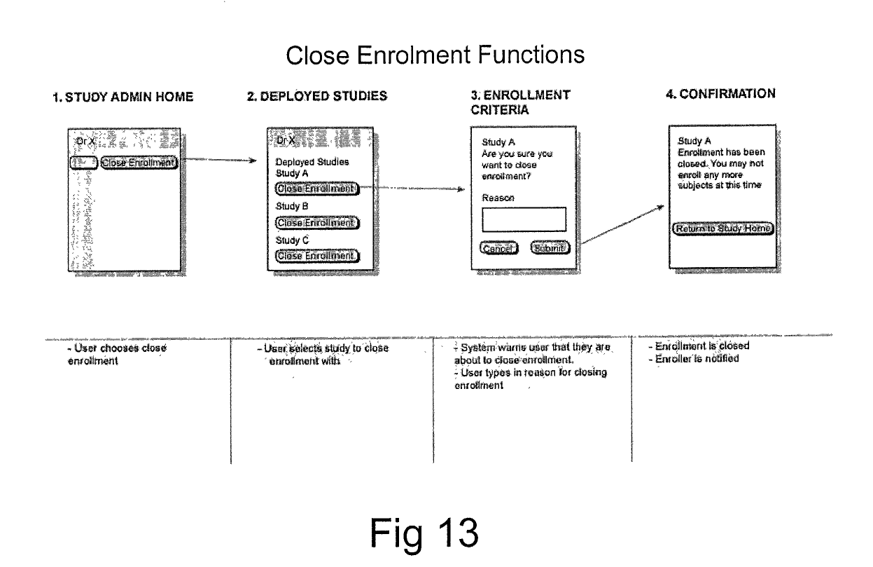

FIG. 13 shows exemplary close enrolment functions in accordance with the invention. In order to access this function, the user must login to the system and must have the appropriate role and associated rights to act as a Study Administrator. It is understood that one or more studies must be previously defined and entered into the system (having opened enrolment), before enrolment can be closed. The close enrollment function is selected and the appropriate study (for which enrollment will be closed) is then identified. The Study Administrator is prompted to close enrolment data including reasons for closing enrolment and the like. Once the close enrollment data is entered into the system, the Study Administrator is presented with a confirmation screen that confirms enrollment is closed.

Study Administrator Function—Define Roles

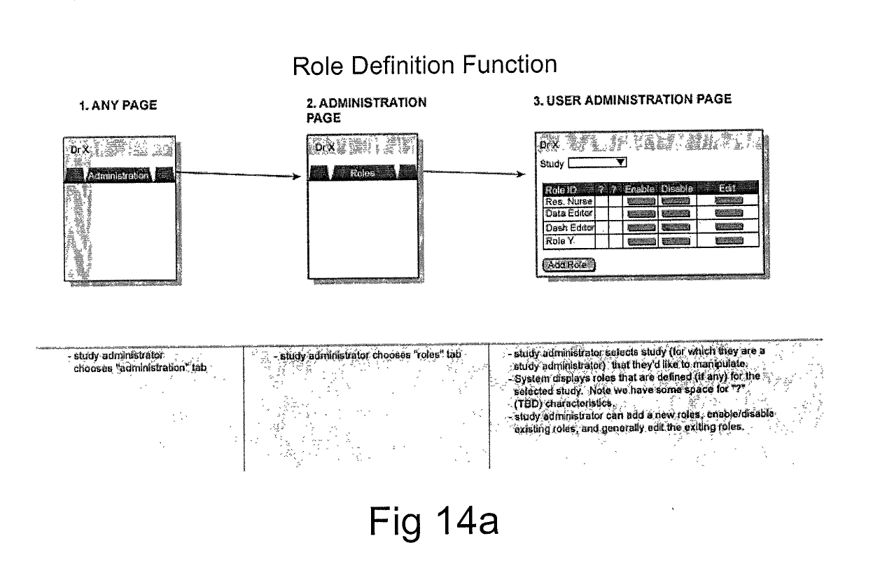

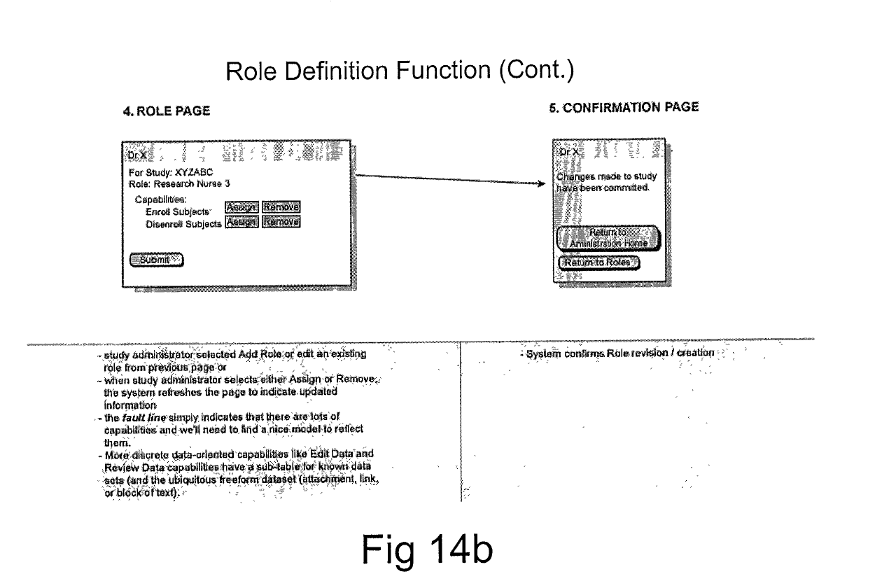

FIGS. 14a and 14b show exemplary role definition functions in accordance with the invention. In order to access this function, the user must login to the system and must have the appropriate role and associated rights to act as a Study Administrator. It is understood that one or more studies must be previously defined and entered into the system before roles can be assigned. The administration tab and then the roles tab are selected. The Study Administrator can then specify the study for which they are defining roles (e.g., via a drop down list). The Study Administrator is then presented with a list of roles that are defined (if any) in association with the selected study. The Study Administrator can add new roles, edit, enable and/or disable existing roles. Each role has associated role data generally defining the security or data access rights associated with the role. For example, a “Research Nurse 3” role can have rights to enroll and/or disenroll subjects. Once the Study Administrator is finished, they click on the submit button. The Study Administrator is presented with a confirmation screen that confirms any changes and stores the changes in the database.

Study Administrator Function—Assign Roles to Users

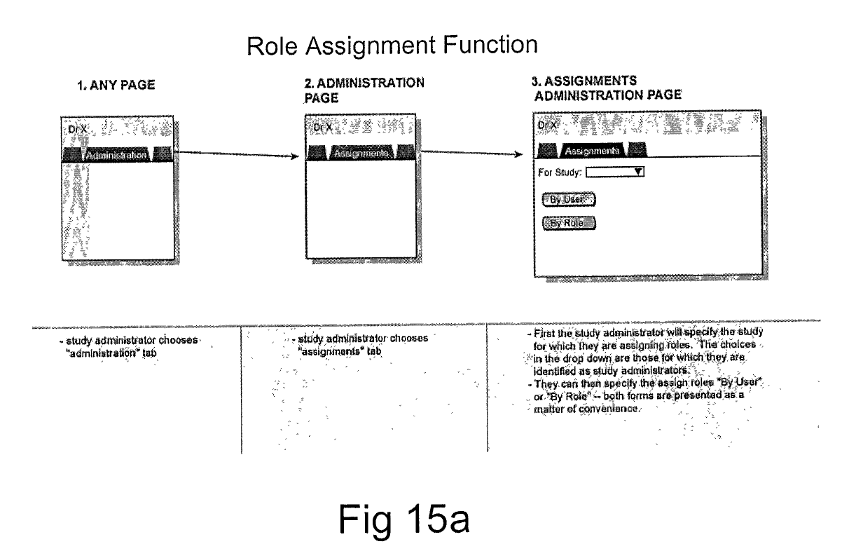

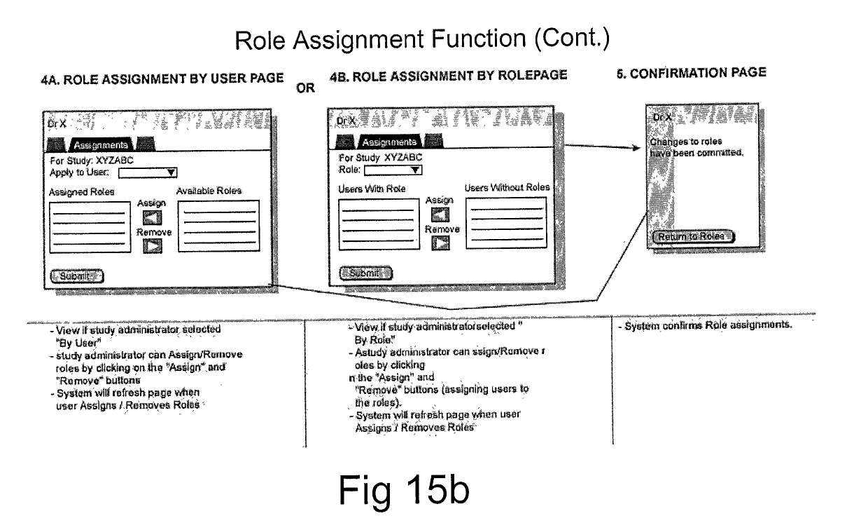

FIGS. 15a and 15b show exemplary role assignment functions in accordance with the invention. In order to access this function, the user must login to the system and must have the appropriate role and associated rights to act as a Study Administrator. It is understood that one or more studies must be previously defined and entered into the system before roles can be assigned. The administration tab and then the assignments tab are selected. The Study Administrator can then specify the study for which they are assigning roles (e.g., via a drop down list). The Study Administrator can then assign roles “by user” or “by role”. If “by user” is selected, the Study Administrator is presented with list of users (e.g., from a drop down list). Once the user is selected the Study Administrator is presented with a list of roles that are assigned to the user and a list of available roles. The Study Administrator can then assign or remove roles by clicking on assign or remove button respectively.

If “by role” is selected, the Study Administrator is presented with list of roles (e.g., from a drop down list). Once the role is selected the Study Administrator is presented with a list of users with the selected role and a list of users without the selected role. The Study Administrator can then assign or remove roles by clicking on assign or remove button respectively.

Once the Study Administrator is finished, they click on the submit button. The Study Administrator is presented with a confirmation screen that confirms any role changes and stores the changes in the database.

Study Administrator Function—Manage Users

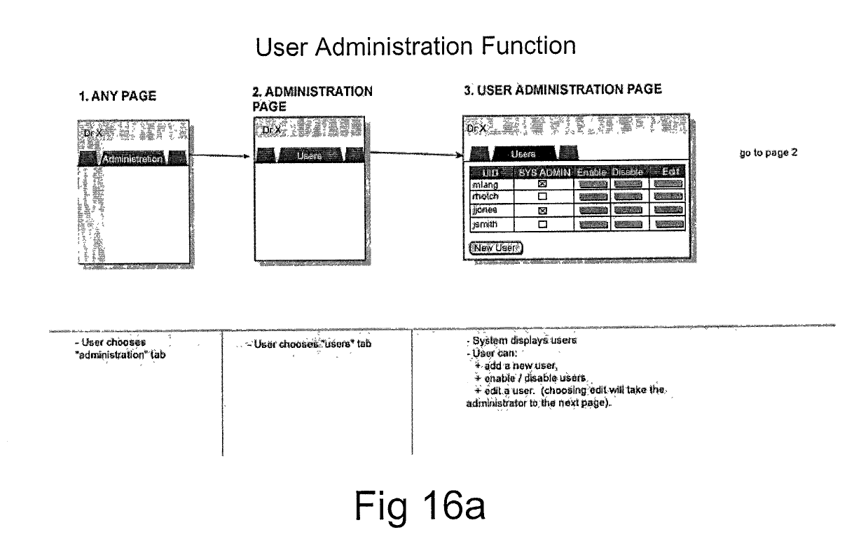

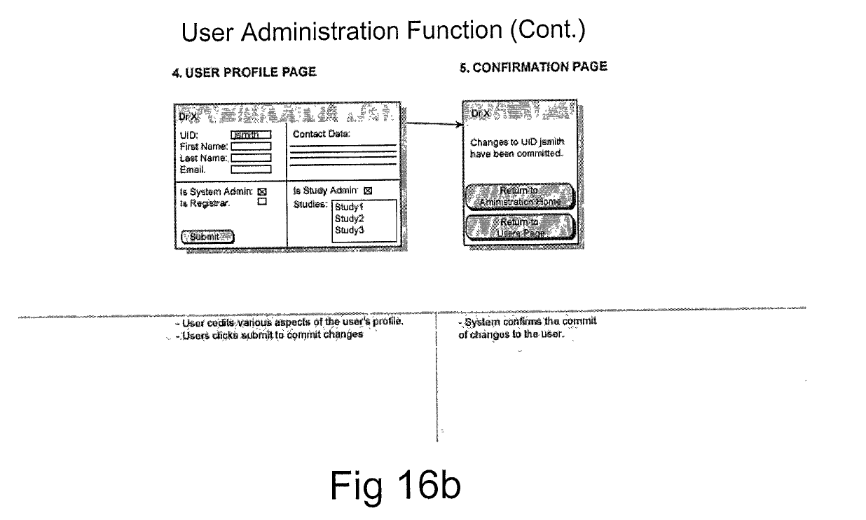

FIGS. 16a and 16b show exemplary user administration functions in accordance with the invention. In order to access this function, the user must login to the system and must have the appropriate role and associated rights to act as a Study Administrator. The administration tab and then the users tab are selected. The Study Administrator is then presented with a list of users (User IDs) that are defined (if any). The Study Administrator can add new Users IDs, edit, enable and/or disable existing User IDs. Each User ID has associated user data that forms a user profile. If the System Administrator wishes to edit or add a user profile, they are presented with a user profile page. User data generally includes the User ID, first name, last name, e-mail address, contact information, studies associated with the user, roles and the like. Once the Study Administrator is finished adding or editing the user profile, they click on the submit button. The Study Administrator is presented with a confirmation screen that confirms any changes and stores any changes to the User Data in the database.

Enroller Function—Enroll Subject in Study

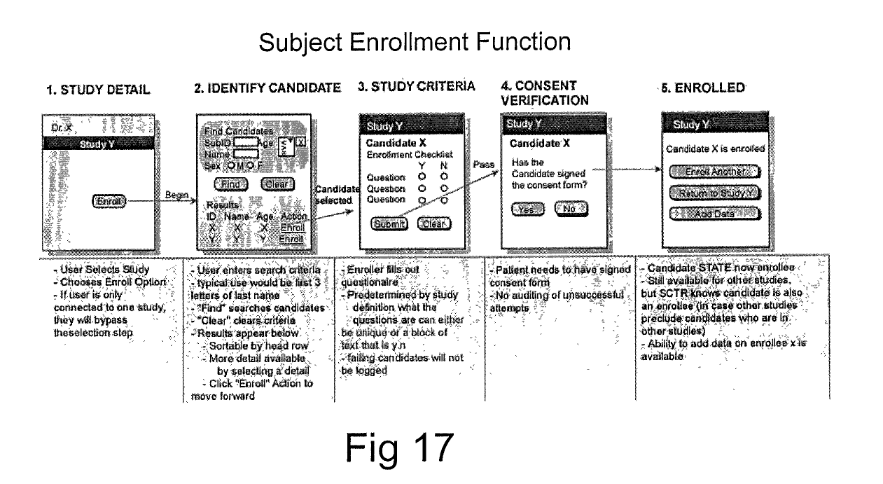

FIG. 17 shows exemplary subject enrollment functions in accordance with the invention. In order to access this function, the user must login to the system and must have the appropriate role and associated rights to act as an Enroller. It is understood that one or more studies must be previously defined and entered into the system (having opened enrolment), before a subject can be enrolled. It is also understood that one or more candidates must be previously registered in the system. The Enroller first selects the appropriate study and identifies the candidate to enroll in the study. Preferably, a search of data or information stored in the system can be performed based on key words, such as the first three letters of a candidates last name or the like. Once a candidate is located, the Enroller can click on the enroll button and begin the process of enrolling the candidate in a study.

The Enroller is then presented with a questionnaire defining study criteria that are predetermined by the study definition. Candidates not meeting the study criteria cannot be enrolled in the study. Assuming the candidate meets the study criteria, the Enroller is asked to verify that the candidate has signed the consent form by clicking on the yes button. Assuming, the Enroller clicks on the yes button, the candidate enrolled in the study. The Enroller is presented with a confirmation screen and the system database is updated as required.

Data Editor Function—Add/Edit Study Data

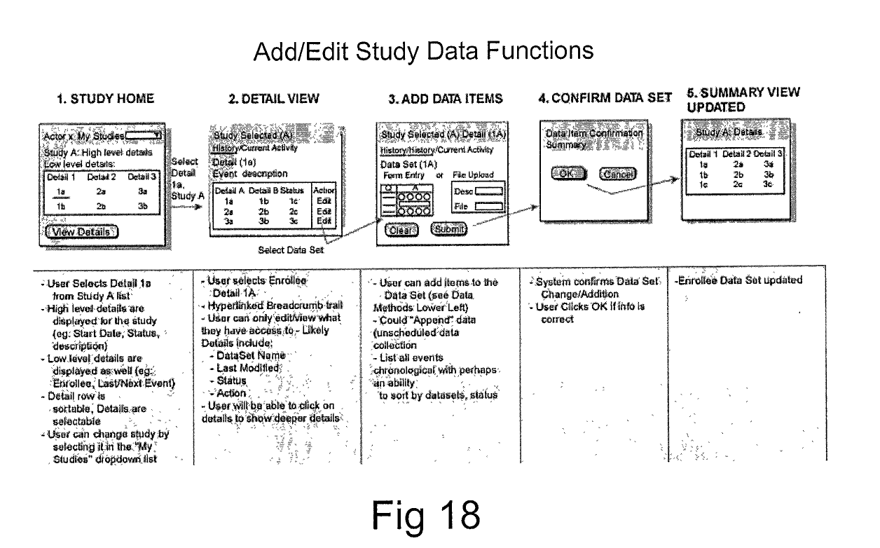

FIG. 18 shows exemplary add/edit study data functions in accordance with the invention. In order to access this function, the user must login to the system and must have the appropriate role and associated rights to act as a Data Editor. It is understood that one or more studies must be previously defined and entered into the system. The Data Editor first selects the study (e.g., from a drop down list). The Data Editor can then view portions of the Study Data broken down into high level and low level data. High level data included study start date status, description and the like. Low level data includes data set names, last modified fields, status fields, action fields and the like. The system preferably keeps a detailed record of data access in the form of audit trails (breadcrumb trials) including information relating to data access (e.g., who, what, when . . . ). The Data Editor can add or edit items (e.g., associated with a given enrollee) in a given data set. Once the data is added or entered, the Data Editor clicks the submit button. The Data Editor is presented with a confirmation screen and the system database is updated as required.

Data Editor Function—Add/Edit Genetics Data

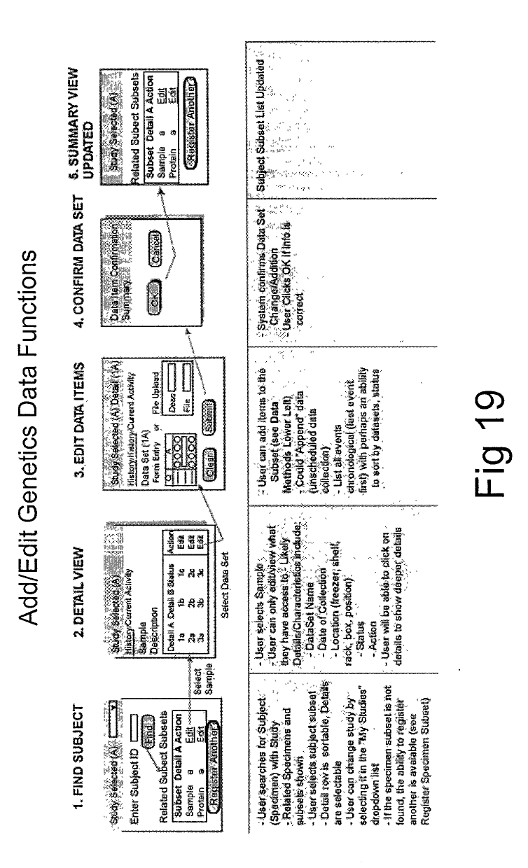

FIG. 19 shows exemplary add/edit genetics data functions in accordance with the invention. In order to access this function, the user must login to the system and must have the appropriate role and associated rights to act as a Data Editor. It is understood that one or more studies must be previously defined and entered into the system. The Data Editor first selects the study (e.g., from a drop down list). The Data Editor then searches for the appropriate subject (specimen) and can view portions of the Study Data pertaining to the specimen (e.g., data set name, date of collection, location, status fields, action fields and the like). As discussed above, the system preferably keeps a detailed record of data access in the form of audit trails (breadcrumb trials) including information relating to the data access (e.g., who, what, when . . . ). The Data Editor can add or edit genetics data associated with the specimen. Once the data is added or entered, the Data Editor clicks the submit button. The Data Editor is presented with a confirmation screen and the system database is updated as required.

Data Monitor Function—Review Data

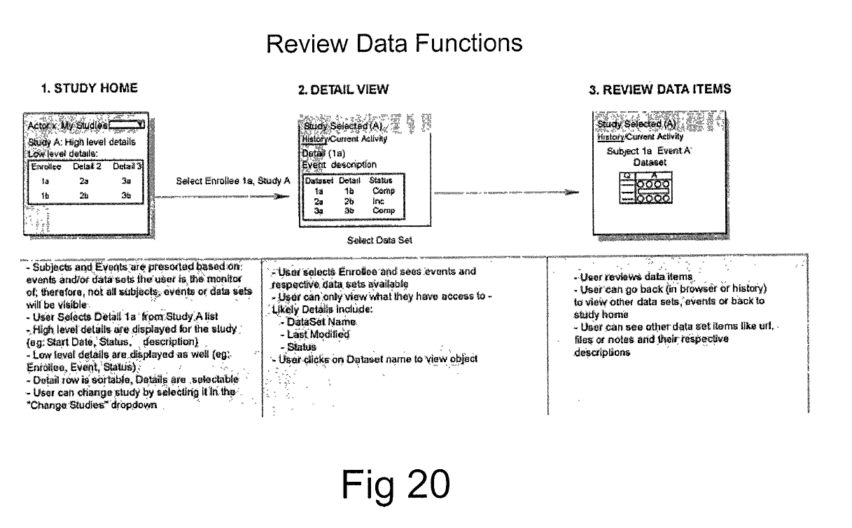

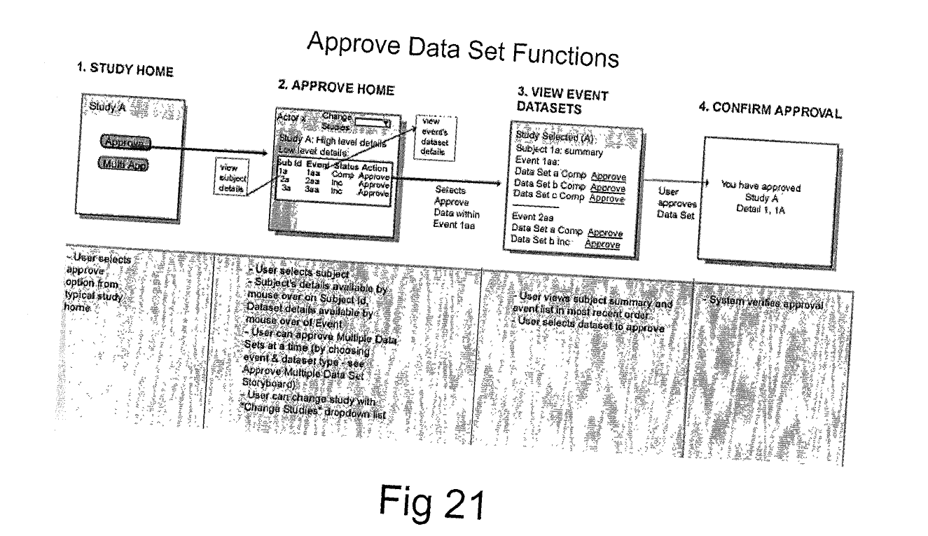

FIG. 20 shows exemplary review data functions in accordance with the invention. In order to access this function, the user must login to the system and must have the appropriate role and associated rights to act as a Data Monitor. It is understood that one or more studies must be previously defined and entered into the system. The Data Monitor first selects the study (e.g., from a drop down list). The Data Monitor is then presented with a portion of the study data organized into a list of subjects and events with associated high and low level details. High level details include study start date, status, description and the like. Low level details include enrollee, events, status and the like. Preferably, the Data Monitor can sort the study data based on various criteria to facilitate data access. The Data Monitor can also select a particular detail for in depth viewing. As discussed above, the system preferably keeps a detailed record of data access in the form of audit trails (breadcrumb trials) including information relating to the data access (e.g., who, what, when . . . ). Once the Data Monitor is complete the system database is updated as required.

Data Administrator Function—Approve Data Set

FIG. 21 shows exemplary approve data set functions in accordance with the invention. In order to access this function, the user must login to the system and must have the appropriate role and associated rights to act as a Data Administrator. It is understood that one or more studies must be previously defined and entered into the system. The Data Administrator first selects the study (e.g., from a drop down list). The Data Administrator then selects the approve option and is then presented with a portion of the study data organized into a list of subjects and events with associated status. The Data Administrator can select one or more subjects or events for approval. Once the Data Administrator is complete the system database is updated as required and an approval confirmation is displayed.

Data Administrator Function—Approve Data Set

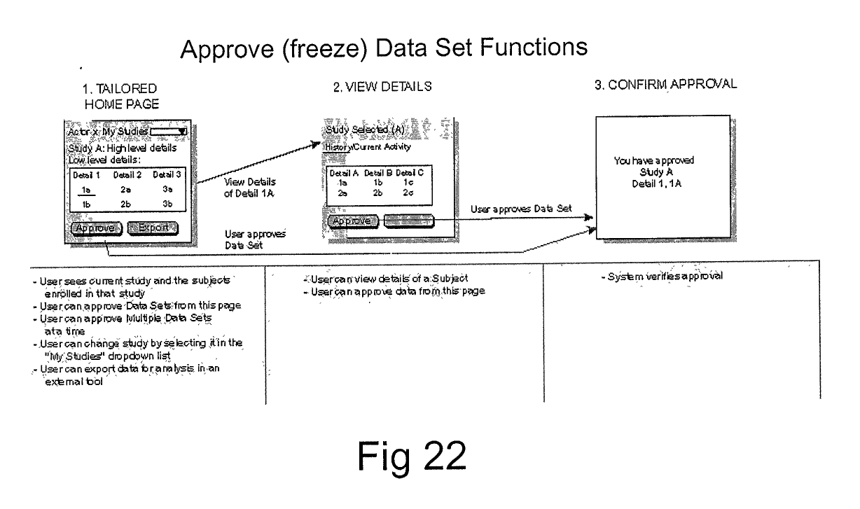

FIG. 22 shows exemplary approve (freeze) data set functions in accordance with the invention. In order to access this function, the user must login to the system and must have the appropriate role and associated rights to act as a Data Administrator. It is understood that one or more studies must be previously defined and entered into the system. The Data Administrator first selects the study (e.g., from a drop down list). The Data Administrator then selects the approve option and is then presented with a portion of the study data organized into a list of subjects and events with associated status. The Data Administrator can select one or more subjects or events for approval and further study. Once the Data Administrator is complete the system database is updated as required and a confirmation is displayed.

Data Administrator Function—Reinstate Edit Capability

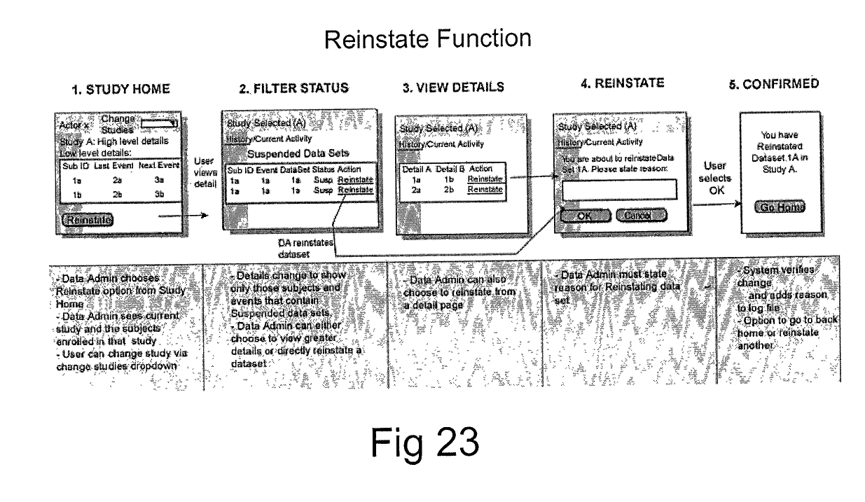

FIG. 23 shows an exemplary reinstate function in accordance with the invention. In order to access this function, the user must login to the system and must have the appropriate role and associated rights to act as a Data Administrator. It is understood that one or more studies must be previously defined and entered into the system. The Data Administrator first selects the study (e.g., from a drop down list). The Data Administrator then selects the reinstate option and is then presented with a portion of the study data by a status organized into a list of subjects and events with associated status. The Study data is filtered to include only subject events having a suspended status. The Data Administrator can select one or more subjects or events for reinstatement. Once the Data Administrator is complete the system database is updated as required (e.g., subject or event status information) and a confirmation is displayed.

Communication Between Users—System Mail

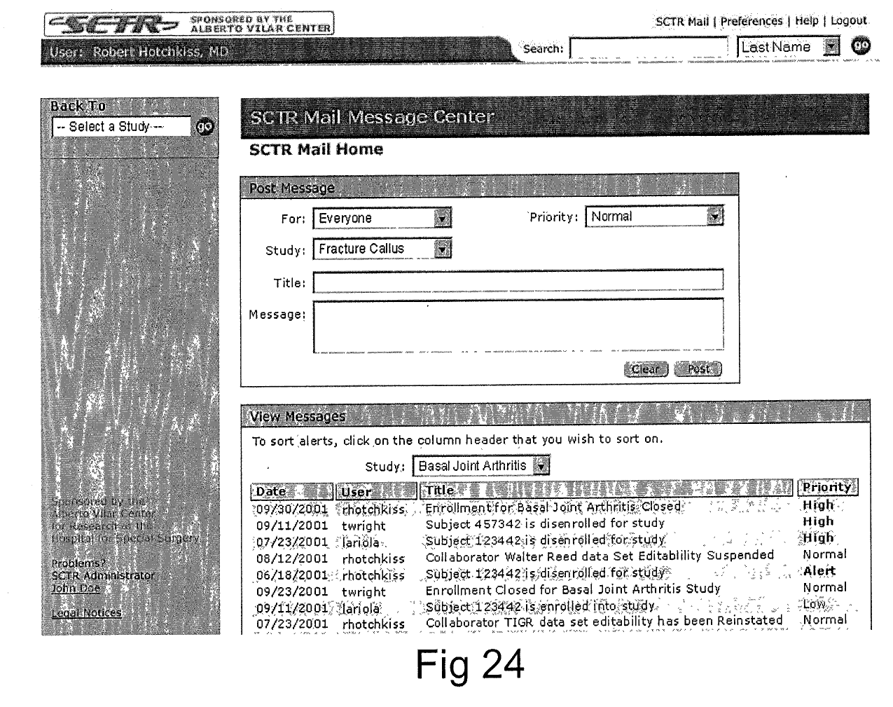

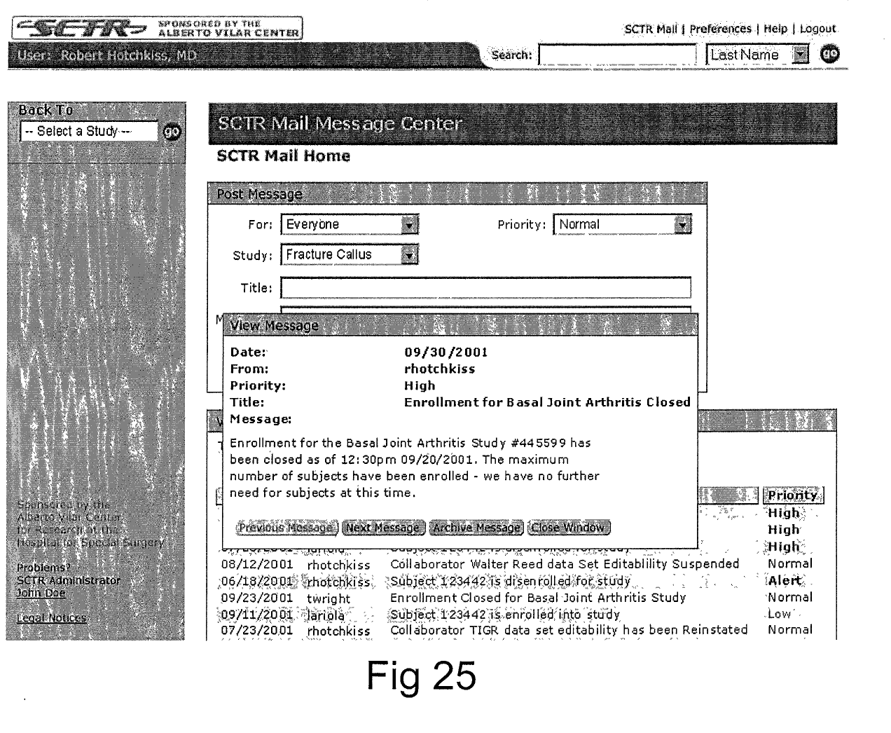

FIG. 24 shows an exemplary mail message center screen in accordance with the invention. In order to access this function, the user must login to the system and must have the appropriate role and associated rights. The mail function generally allows users to post or send new messages (outgoing) and read or review messages from other users (incoming). In order to compose a new message, the user first selects a recipient (e.g., from a drop down list). The system limits the list of recipients to those users having the proper role (e.g., users having a role in association with the desired study). The user can also select a priority indicator for association with the message (e.g., normal, high, alert . . . ). The user then enters a title and the body of the message and selects the post button to send the message to the recipients. The message is then electronically transmitted to the recipient(s) in a secure fashion. The system advantageously provides a secure environment within which users can communicate about a given study. No messages can be sent or received in connection with a given study unless the author and the recipient(s) have been assigned the proper role in connection with the study. The user can also read messages that were sent by other users. FIG. 25 shows an exemplary mail message in accordance with the invention.

Events:

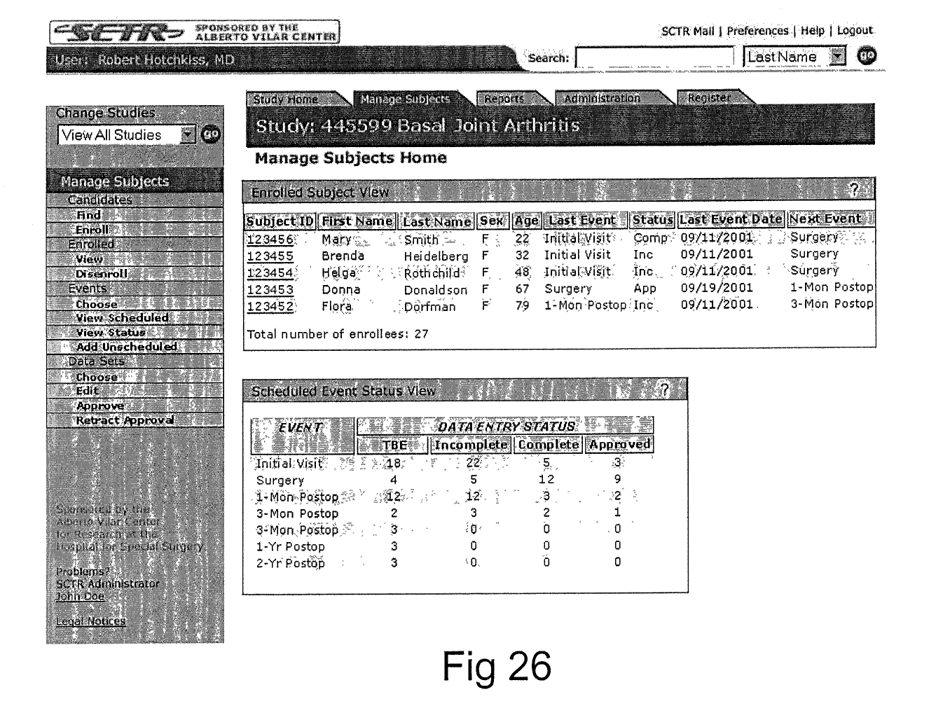

FIG. 26 shows an exemplary listing of scheduled events. Each study may have one or more expected events that are associated with a subject or patient. In this example, each subject is to have an initial visit, surgery and several follow-up visits. These events are preferably defined at the time the study is defined. The system preferably tracks the last event associated with a subject, the status of that event and the next event. As each event takes place the system database is updated (by the authorized user) to reflect each subject's progress towards completion of the expected events.

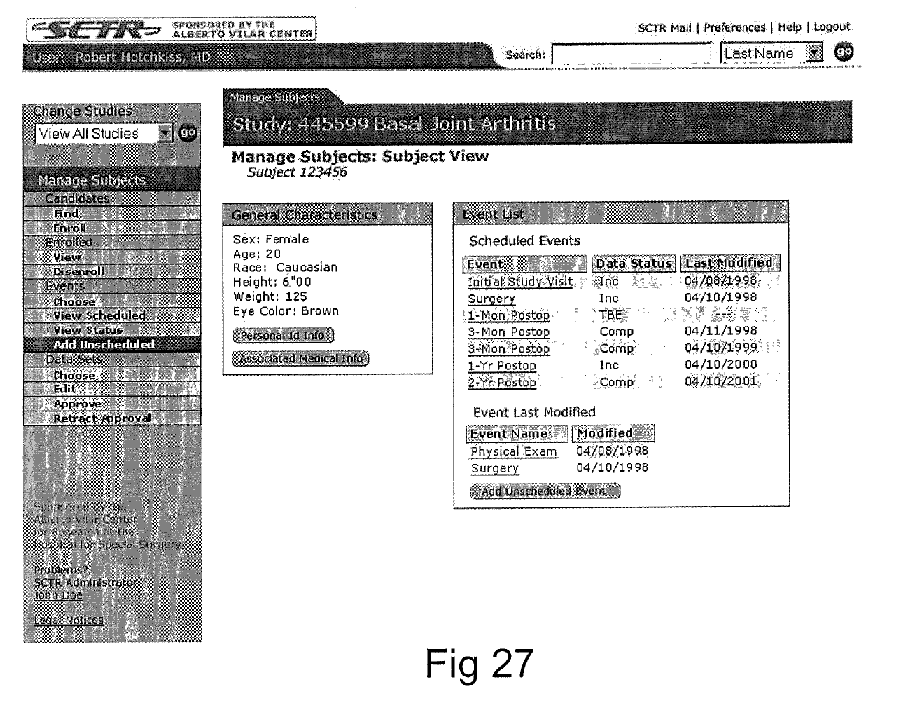

In order to provide maximum flexibility, the system is also operable to track unexpected or unscheduled events. Preferably, unscheduled events are associated with a particular subject. FIG. 27 shows an exemplary detailed view of a particular subject listing both scheduled and unscheduled events. In this example, two unscheduled events have already been added in connection with this subject (an additional physical examination and surgery).

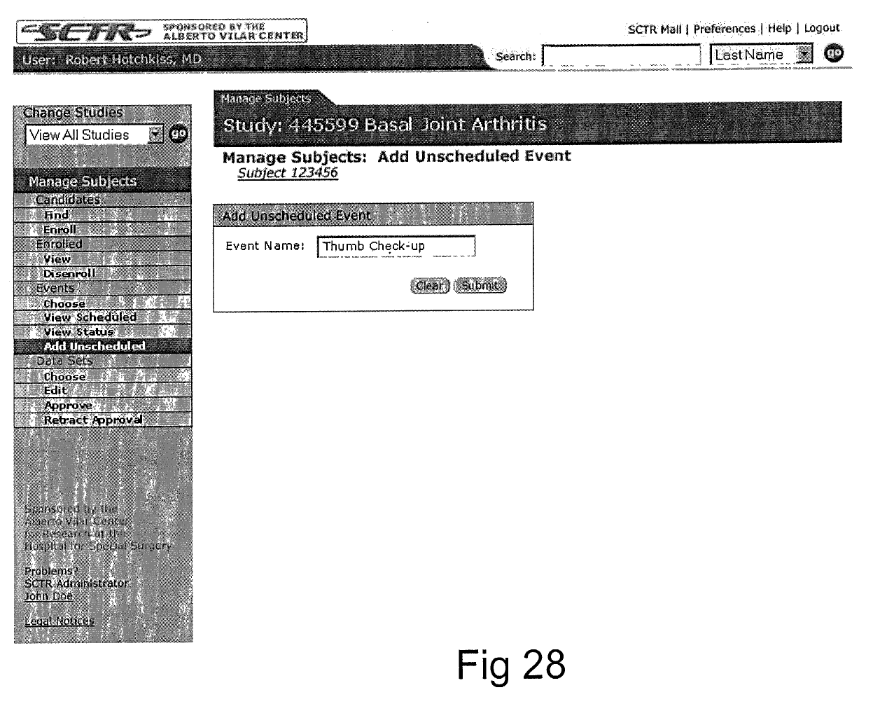

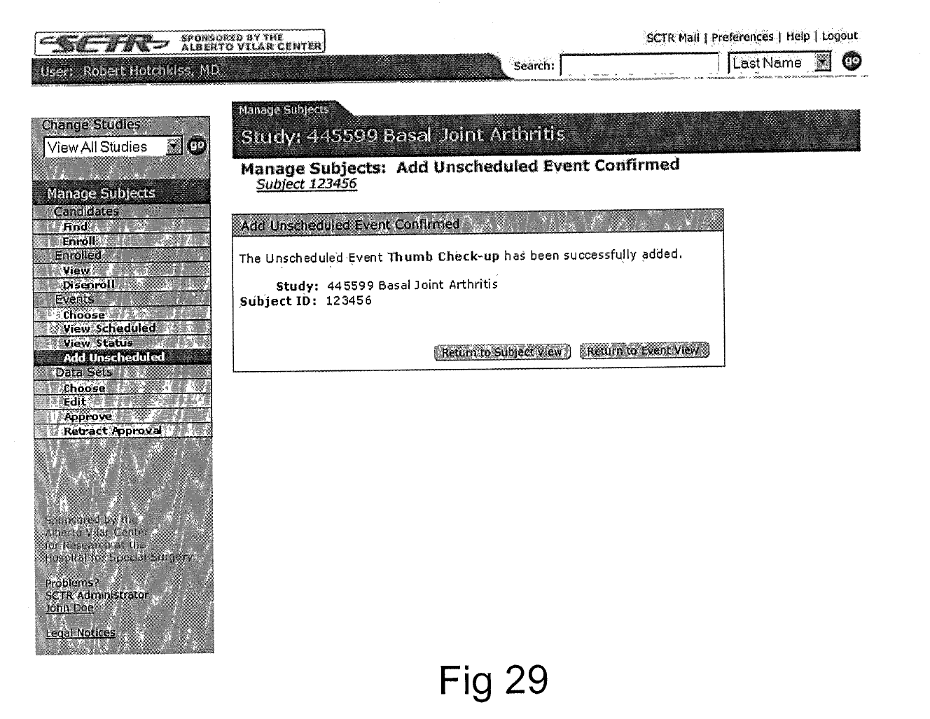

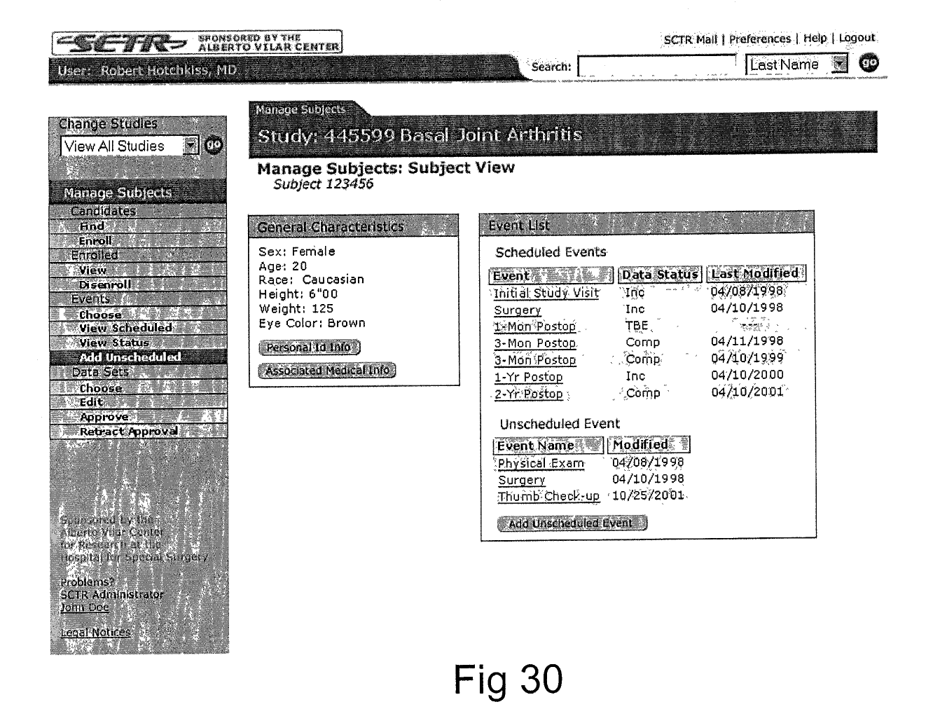

In order to add another unscheduled event, the user clicks on the “add unscheduled event” button. The user is presented with a data input screen and enters the unscheduled event name and clicks on the submit button. See e.g., FIG. 28. The user is then presented with a confirmation message. See e.g., FIG. 29. Returning to the detailed view for this particular subject, the newly added unscheduled event is added to the event list. See FIG. 30.

Study Authorship

The process for manually creating or authoring a study for use in conjunction with the system is described below. It is understood that some or all of the steps set forth below can be automated to assist in the authoring process. In general, the basic components in authoring a study include, but are not limited to: 1) Gather Requirements of Study, 2) Assess Risk/Impact to Existing Software, 3) Transcribe into Database, 4) Implement Any Needed Software Changes, 5) Rollout to Study Participants.

Gather Requirements of Study

Typical requirements needed to properly author a study include, identification of participants and associated roles, datasets and documents involved, and the event schedule. Preferably, this information is gathered using a questionnaire to assist in the process. Exemplary questions for gathering study requirements are set out in Table 3 below:

TABLE 3

| | Exemplary Questions |
|---|---|
| 1 | What is the study's name? |
| 2 | Do you have any study reference material? These would be |
| | documents that are relevant to all of your users such as the grant |
| | proposal or specific aims of the study. Electronic documents are |
| | preferred. |
| 3 | How many subjects are expected to take part in the study? |
| 4 | How many colleagues/collaborators are involved in the execution |
| | of the study? What is their contact information? |
| 5 | What Roles are envisioned? Associate each role(s) with a |
| | collaborator listed in question 4. This includes identifying the |
| | Principal Investigator for all participating Research Nurses. |
| | Collaborators can have as many roles as desired. |
| 6 | What are the Scheduled Events and what does their calendar look |
| | like? Consider complexities such as decision point branching, |
| | concurrent events, and merge points. |
| 7 | What datasets must be captured? Provide copies all Forms |
| | (electronic and/or hardcopies) and the Inclusion and Exclusion |
| | criteria for enrollment into the study. Identify whether a given |
| | dataset is collected over many events, or only one-time. |
| 8 | Do any of the data sets require specialized views for the given |
| | collaborators? For example, will one collaborator be able to see |
| | only part of the data, edit another part and not see another part? |
| 9 | Is there any existing data? If a study is already underway, will the |
| | previously collected data need to be loaded into the study or will it |
| | simply be re-entered by the collaborators of the study? |
| 10 | Are there any special reports required of the study? If so, provide |
| | illustrations and/or examples that describe the desired reports. |

Assess Risk/Impact to Existing Software

Preferably, the system as described above is flexible enough to accommodate implementation of new studies without any changes to the system software. Table 4, sets forth several exemplary questions for systematically assessing risk/impact to existing software.

TABLE 4

| | Exemplary Questions |
|---|---|
| 1 | What if any, software changes must be made? |
| 2 | What, if any, new reports must be made? |
| 3 | Will the importation of data be required and how difficult will it be? |
| 4 | What is the level of effort to transcribe the study into SCTR? |

Preferred System Database Design

Once the study requirements are gathered, a study must be captured in the system database. The system preferably includes a flexible database structure that will facilitate the study definition process for a broad range of studies. The implementation of a preferred database structure as it relates to the storage of exemplary data is set out below.

Dataset Definitions—MetaData

As discussed above, datasets are comprised of a collection of data items. The structure of datasets and all associated data items within a datatset are defined using metadata rather than by fixed tables and attributes. Each data item is defined to be a specific data type. Data types include the typical scalar types, such as numeric, string, and date/time. Data types can also be single- or multi-selection lists, which enforce the value(s) to be constrained to a predefined list. When multiple data items use the same selection list for their response domain (for example, many data items may have acceptable responses limited to “yes/no” or “true/false”), then the selection list only needs to be defined once, and can be referenced many times. Additional data types include large (up to 4 GB) binary or character data. Data items defined to handle large binary data can be used to store documents of proprietary format, such as a spreadsheets, presentations, or word processing documents. The metadata at the data item level permits the specification of default values, maximum/minimum numeric values and format masks for character strings. Data items are designated as either required or not required, which permits the system to derive their completion status. Data items are also designated as nullable or non-nullable. A nullable data item is one that can be left blank during the editing and saving cycle, (even though it may be required from a completion status standpoint). When a data item is non-nullable, there must be a value present before the user can proceed (e.g., go the next screen).

Exemplary Database Tables

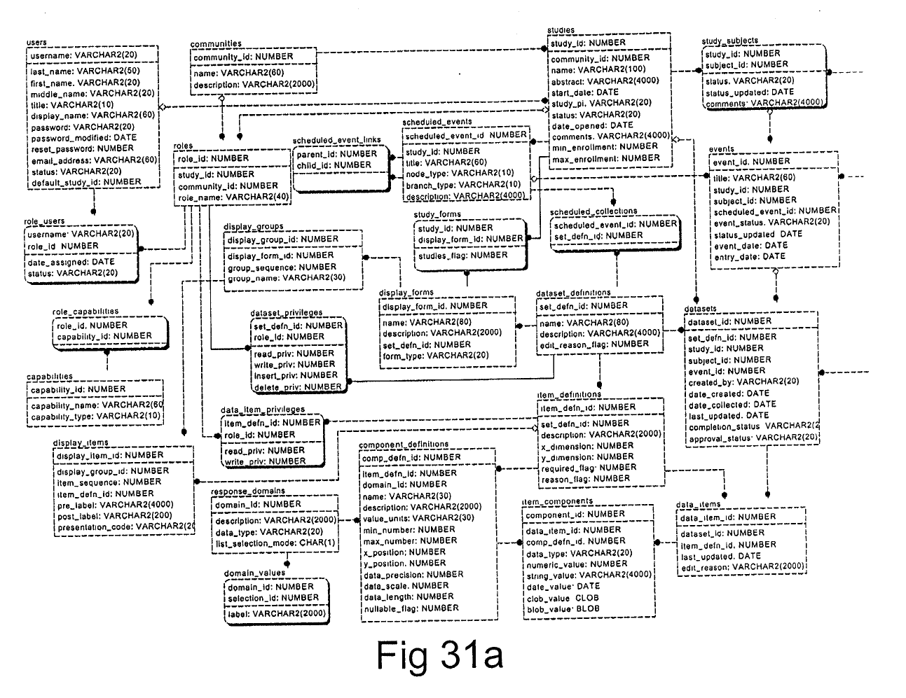

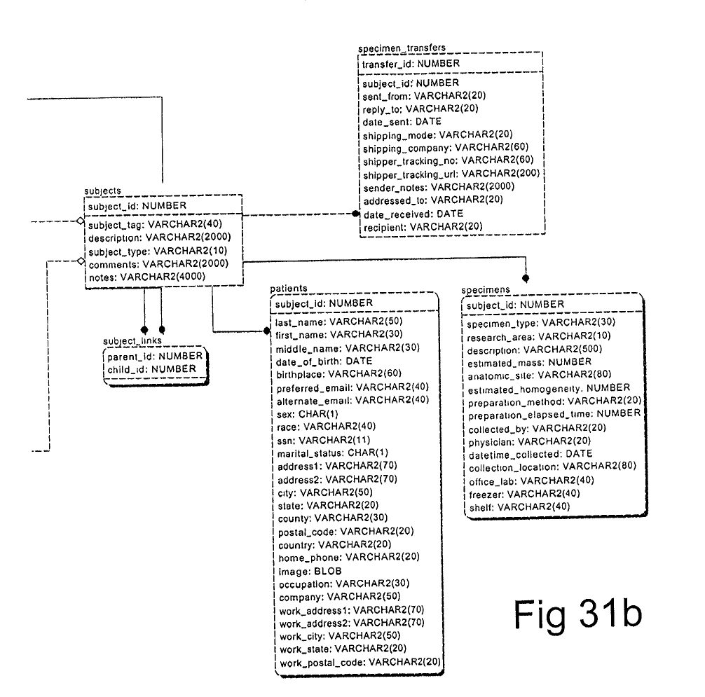

FIGS. 31a and 31b show exemplary database tables in accordance with the invention. Appendix A includes a brief description of the individual fields in the tables used in connection with dataset definitions, dataset storage, dataset display, data access, capabilities and roles and events. The inter-relationship of the various tables and fields is discussed below.

Exemplary Dataset Definition—DASH Form

As discussed above, a dataset is generally a group of data. In order to store data in the system, a dataset must first be defined. The system includes a set of database tables used to store dataset definitions. The dataset can include a single item of data or can include many data items. For purposes of discussion, the system can store data collected in conjunction with a DASH (disabilities of the arm, shoulder and hand) form or questionnaire. The DASH is a standardized questionnaire that assists practitioners in treating upper-limb disorders. The DASH was developed in a collaborative effort of the Institute for Work & Health and the AAOS/COMSS/COSS-Outcomes Data Collection Instruments. Additional information relating to the DASH from can be obtained from http://www.iwh.on.ca/Pages/Research/DASH.htm.

In general, the DASH Outcome Measure was developed to measure disability and symptoms related to upper limb musculoskeletal disorders. The DASH generally includes a plurality of questions relating to a subject's physical function, symptoms and other information. The DASH is typically completed by a study subject and must be entered into the system. A given study subject will typically complete several DASH forms during a study. An typical DASH form request different types of information as outlined generally below in Table 5.

TABLE 5

| Data Type | Exemplary DASH Question |
|---|---|
| Text | Patient Name, Reason for visit |
| Number | DOB/Age |
| Question | Have you had previous surgery? (Yes, No) |
| with fixed | Areas of body: (Finger, Wrist, Hand Forearm, Elbow) |
| a set of | Side of Body (Right, Left) |
| responses | |

The DASH form also includes a series of questions. For example, a subject is asked to rate their ability to perform a plurality of activities on a scale of 1 to 5 (1=No Difficulty, 2=Mild Difficulty, 3=Moderate Difficulty, 4=Severe Difficulty and 5=Unable). Exemplary tasks include: Open a tight or new jar, write, turn a key, prepare a meal, push open a heavy door etc. etc. The sum of all of these numeric responses is compiled as a score upon completion of the form.

The definition of a DASH form within the system proceeds as follows. The DASH form and all associated questions and responses are preferably defined as a single data set. Accordingly, a single entry or record is created in the dataset_definitions table. See Appendix A. The record generally includes a primary key, a name and description. A typical DASH form may request 60 items of information from a study subject. Accordingly, 61 items (e.g., 60 responses and the score) must be defined.

For each item, a record is created in the item_definitions table. Each record has a foreign key (set_defn_id) relating to the dataset_definitions table. Each record has a description, an X and Y dimension to define the number of components that make up the item as well as other fields that are generally self-explanatory.

Each record defined in the item_definitions table also has at least one associated record defined in the component_definitions table. For example, if item_definitions:x_dimension and item_definitions:y_dimension (for a given item) are both equal to 1, a single record is defined in the component_definitions table. If item_definitions:x_dimension=2 and item_definitions:y_dimension=1, two records are defined in the component_definitions table etc., etc. An example of a data item having two components would be blood pressure (systolic/diastolic).

Each record in the component_definitions table has a foreign key (item_defn_id) relating to the item_definitions table. Each record also has a name, a description and several fields that are generally self-explanatory. See Appendix A. Each record in the component_definitions table also references a corresponding record in the response_domains table. Each record in the response_domains table includes a primary key (domain_id) relating back to the component_definitions table. The response_domains table also includes a description, list selection mode and a data type (e.g., STRING, NUMERIC, DATE, LIST, BLOB (binary large object), CLOB (character large object)).

As discussed above, some data items (or components) may have a predefined range of values (Yes/No, 1-5, etc. etc.). In this case, a corresponding record is created in the domain_values table. In general, the domain_values:domain_id field is the foreign key to response domains. The domain_values:label field contains a lists of actual values (e.g. “Yes”, “No”, “True”, etc.)

Ultimately, the response_domains:data_type field defines the data type for every component of every data item in every dataset. For example the “Patient Name” and “Reason for visit” portions of the DASH form correspond to separate data items, each having a response_domains:data_type=STRING. Each of these items may be defined with a different string length (via component_definitions:data_length). In the case of a DASH question such as “Have you had previous surgery”, single record are defined in the item_definitions table, component_definitions table and the response_domains table. The response_domains:data_type field=LIST and a record is created in the domain_values table with the domain_values:label field including the possible responses Yes and No. Similarly, the DASH question “Areas of body:” has corresponding single records defined in item_definitions table, component_definitions table, response_domains table and domain_values tables. However, the domain_values:label field includes the possible responses Finger, Wrist, Hand Forearm and Elbow. A data item definition corresponding to Age or the score would have single records defined in item₁₃ definitions table, component_definitions table and the response_domains (response_domains:data_type field=NUMBER). A data item definition corresponding to DOB would have single records defined in item_definitions table, component_definitions table and the response_domains (response_domains:data_type field=DATE). It is understood that other datasets could include data items such as binary or character based files (e.g., and x-ray image or document) having a similar set of records defined in the tables discussed above with an associated response_domains:data_type field=BLOB or CLOB respectively.

Exemplary Dataset Storage—DASH Form

After a dataset is defined, the system is operable to store the dataset data (e.g., responses) in the database. Appendix A includes a brief description of the individual fields used in connection with dataset storage. Continuing with the DASH form example, each time a subject completes a DASH form and the data is entered into the database, a corresponding set of records is created in the appropriate database tables. A single record is created in the datasets table. This table includes various information such as a dataset ID, date of collection and other fields that are self explanatory. Each data item (e.g., 60 responses and the score) has a separate record in the data_items table. This table includes several keys to appropriate tables as well as notes relating to why data item was edited.

The data_items: data_item_id field is a primary key used to relate the item_components table. This table includes the fields for storing the data type fields (DATE, LIST, NUMBER, STRING, etc.) for storing the actual data item or a pointer to the data item (numeric_value, string_value, blob_ptr, clob_ptr or date_value) as well as other fields that are self explanatory.

Display Forms

The presentation of datasets to the user is accomplished through a display forms. A display form is associated with one dataset definition, and describes how the corresponding fields of the dataset should be presented on a given display device. Like datasets, display forms are also metadata-based. A given dataset can be presented in a variety of formats by defining a separate display form for each format. Similarly, a given dataset can be presented on a variety of different platforms by defining separate display forms for each platform. For example, the same dataset could be rendered differently on a Web browser, a PDA, or a touch screen tablet. Likewise, the same dataset could be presented in English or Spanish without any modification by simply associating the appropriate display form with the target dataset definition.

Continuing with the example from above, a typical DASH form is subdivided into several groups of questions and responses. Accordingly, the display forms preferably accommodate the grouping of data for an enhanced user display.

Exemplary Dataset Display Tables—DASH Form

Appendix A shows exemplary tables that are used to generate forms through which the user can access the datasets. Each display form relates to a single dataset definition, but a given dataset definition can be displayed differently by defining/using multiple display forms.

The display_forms tables includes fields for storing the display form name, type, description and the like. The display_forms:set_defn_id field is a foreign key to the dataset_definitions table discussed above. The display_forms:display_form_id field is the primary key relating to the display_groups table. This table includes one record for each group of data to be displayed such as the group name, sequence and the like. The display_groups:display_group_id field is the primary key relating to the display_items table.

The display_items table includes one record for each item in the dataset to be displayed. The display_items:item_defn_id field is the foreign key to the item_definitions table discussed above. The display_items:pre_label field contains the text to be displayed prior to displaying the actual data (e.g., response to question on the DASH form). Continuing with the DASH form example, a dataset item relating to each question on the DASH form is defined as set out above. One of these data items relates to the response to the DASH form question “Have you had previous surgery?”. Accordingly, the corresponding display_items:pre_label field is set to “Have you had previous surgery?”. This text is actually displayed preceding the actual response stored in the database in connection with the particular DASH form (Yes or No). Any text that for display following the actual data (e.g., response) is stored in the display_items:post_label field. An example of typical post text would be text relating to units associated with a response (e.g., pounds, centimeters, degrees etc. etc.). If a display is desired in another language, another display form is defined with the appropriate text in the display_items:pre_label and display_items:post_label fields. It is also understood that an unlimited number of display forms can be defined to facilitate the display of the same data in various formats (e.g., for rendering differently on a Web browser, a PDA, or a touch screen or the like).

Data Access

A user's access to a particular item of data is regulated by the user's role in connection with either a dataset definition encompassing the data item in question or the individual data item definition. In most cases it is sufficient to assign data access permissions to a role at the dataset definition level, but when fine-grained access is necessary, the role can be granted read/write access on the data item (field) level. When there is a conflict between the access rights between the dataset and data item level, the access granted on the data item level takes precedence, or overrides the access on the dataset level.

Appendix A shows exemplary database tables that allow data access to be granted to roles, either at the dataset definition or the data item definition level (see—dataset_privileges and data_item_privileges tables). Each dataset has at least one record in the dataset_privileges identifying a role and the associated data access privileges. The dataset_privileges:set_{—defn}_id field is the foreign key relating to the dataset_definitions table and the dataset_privileges:role_id field is the foreign key to roles (discussed in more detail below). The remaining fields are self explanatory.

To the extent required, records can be added to the data_item_privileges table to restrict access to specific data items. The data_item_privileges:item_defn_id field is the foreign key relating to the item_definitions table. The data_item_privileges:role_id field is the foreign key to roles. The remaining fields are self explanatory.

Roles and Capabilities

Each role has one or more capabilities that are associated with it. Within the database, each role is identified by a unique role_id. The different roles and their associated capabilities are specifically defined for each study. Although roles are not predefined in the application, the capabilities are. Specific capabilities entitle the user having the associated role to specific functions of the application. Even the menu items and navigational controls of the user interface are affected by the capabilities of the user.

The same role name may be reused in multiple studies, but for each occurrence of a role name, a unique role identifier is created. For example, most studies will have a role named “Study Admin”, but these roles occur in different studies, and therefore a different role_id is used. Preferably, the system will allow various parts of a study, including role creation, to be “cloned” or copied. This will simplify the somewhat tedious task of defining new roles with their associated capabilities, since they can be easily replicated from one study to another. As mentioned earlier, the role names are not pre-defined within system and are defined by the study and community administrators. However, the capabilities that can be associated with roles, are pre-defined. Users are required to have specific capabilities (by way of their assigned roles) to perform many of the functions within system.

Appendix A shows exemplary database tables that allow roles to be created for each study, and allow users to be given one or more roles, and for roles to be associated with one or more capabilities. Each role has an associated record in the roles table. This table includes fields identifying the role name, study and the like. The role:role_id field is the primary key. The roles:study_id filed is the foreign key relating to the studies table.

The role_capabilities table contains one record for each capability associated with a given role. The roles:role_id field is the foreign key to the roles table. The roles:capability_id field is the foreign key to the capabilities table. The role_users table includes one record for each user that is associated with a given role. The role_users:role_id field is the foreign key to the roles table. The role_users:username field is the foreign key to users table. The remaining fields are self explanatory.

The capabilities table includes one record for each capability defined in the system. This table includes fields for storing the name of capability, type of capability and the like. The capabilities:capability_id field is the primary key. As discussed above, the various capabilities are pre-defined along with the logic required at the application level to implement the capabilities.

Events

Events refer to an actual occurrence in time, in which there is some interaction or interdiction with the study subject. Usually one or more datasets are associated with the event. Events can be either be “scheduled” or “unscheduled”. When the event corresponds to an activity proscribed by the study definition, the event is considered a scheduled event. An event that is unexpected is an unscheduled event. The study definition includes a list of datasets to be collected for all scheduled events.

When the study is authored, the list of expected, or scheduled, events is known. The data model permits the sequential ordering of these expected events. The model also allows branching event paths, and decision events, in which one of various paths is selected.

Appendix A shows exemplary database tables used to record the occurrence of events and to define what events are expected (i.e. scheduled) for a study.

The events table includes one record for each event (scheduled or unscheduled) entered into the database. This table includes fields for the event name, status, date and the like. The events:event_id field is the primary key. The events:study_id field is the foreign key to the studies table. The events:subject_id field is the foreign key to the subjects table. The scheduled_events table includes one record for each scheduled event. This table has fields for storing the name of the event, associated study, and type of event (node_type and branch_type) and the like.

Subjects and Specimens

Each subject is given a unique identifier, or subject_id. Subjects typically studied in clinical research are human patients. In many cases, the human subjects may provide a specimen of blood or tissue as part of the study. The specimens are also given a unique identifier, or subject_id. Specimens are associated with the contributing “parent”, if that information is known, so that any experimental research derived from the specimen can be traced back to the source subject. Specimens can be further divided into multiple samples. Each sample also has a unique identifier that can be traced back to its source.

Within the database, the term subject is used in a broad sense and refers to any entity that may be the subject of a study. This broad definition of subject applies to the following examples: human subjects, animal subjects, specimens, samples, medical devices, prosthetics, cadavers, and cell lines. Each of the subject types is assigned its own unique subject_id. Even a pool of specimens may be considered a subject, and is therefore assigned a subject_id. This model permits specimens and samples to be related to their source. It also allows a pool to have multiple sources (if known), or otherwise composed of anonymous constituent elements.

Sharing of Subject Data Across Studies

The system can optionally provide for the sharing of a subject's data across studies. Since each subject (or specimen, sample, etc.) is given its own unique subject_id, there is an implicit connection between all of that subject's study data and registration data. Accordingly, the subject doesn't need to be re-registered and the associated data does not need to be re-entered for each study. The availability of a single subject's datasets, across studies, may prove to be invaluable in conducting research not foreseen when the data is originally collected.

Data Privacy

In keeping with federal requirements, only those users who are granted permission can view the privacy data of human subjects. Privacy data generally includes one or more fields of private information relating to a study subject or candidate (e.g., name, address, social security number, e-mail address and the like). The capability “View Privacy Data” can be granted to any community or study role that should have access to personally identifiable data. For any user of the application who does not have this capability, the privacy data is rendered as a string of asterisks (“**********”).

Data Encryption

Different levels of data encryption are compatible with the invention. In a simple example, only user passwords are encrypted. When the user resets their password, it is stored in the database in encrypted form using appropriate database utilities (e.g., built in to Oracle 9i). This provides enhanced security in the event that access is gained to the system database via alternative means (e.g., report writers, data mining tools and the like). In this event, the database contains encrypted information as opposed to character information.

An exemplary encryption algorithm is DES (Data Encryption Standard) which was developed by the Department of Defense, and is used to encrypt passwords in various operating systems. When a user attempts to log in to the application, the password is encrypted and compared to the encrypted password stored in the database. If the two encrypted passwords match for the given user, the he is considered authenticated and allowed into the application.

Audit Trails

As discussed above, the system preferably keeps a detailed record of data access in the form of audit trails (breadcrumb trials) including information relating to access of specific data items. Audit information is preferably maintained in at least one audit trail table having a plurality of records. Each record corresponds to an event that changes the value of a data item (i.e., data is added to the database or existing data is modified). For example, when a data item is added to the database, an entry is created in the audit trail table. The record preferably identifies the data item, the user, the date and time of access. Each time that data item is modified, another entry is created in the audit trail table, again identifying the data item, the user, the date and time of access. The audit table can also include the actual data value. Storage of the actual data value allows the audit table to provide a complete revision history of a given data item, including the record of the actual changes made.

While this invention has been described with an emphasis upon preferred embodiments, it will be obvious to those of ordinary skill in the art that variations in the preferred devices and methods may be used and that it is intended that the invention may be practiced otherwise than as specifically described herein.

### Exemplary Database Tables

1. Dataset Definitions—The following tables are used to define the structure of a dataset definition.

dataset_definitions

set_defn_id—primary key

name—used by study author for reference; not displayed to user

description—used by study author for reference; not displayed to user

item_definitions

item_{—defn}_id—primary key

set_defn_id —foreign key to dataset_definitions table

description—used by study author for reference; not displayed to user

x_dimension—for composite data item; # of x-axis components (usually 1)

y_dimension—for composite data item; # of y-axis components (usually 1)

reason_flag—if modifying this item requires user to enter a reason

required_flag—if this item must be filled in for dataset to be complete

component_definitions

comp_defn_id—primary key

item_defn_id—foreign key to item_definitions table

name—used by study author for reference; not displayed to user

domain_id—foreign key to response_domains table

description—used by study author for reference; not displayed to user

value_units—defines the unit of measure for this data item (e.g. grams)

x_position—which component of matrix or array along x-axis (usually 1)

y_position—which component of matrix or array along y-axis (usually 1)

min_number—for numeric data, minimum number allowed

max_number—for numeric data, maximum number allowed

data_precision—number of significant digits in numeric data

data_scale—number of fractional digits of numeric data

data_length—length of string or numeric data

nullable_flag—component can be left blank on input and editing

format_mask—input mask to format input (e.g. SSN: “999-99-9999”)

default_value—pre-load new item component with this value

response_domains

domain_id—primary key

description—used by study author for reference; not displayed to user

list_selection_mode—for lists of values (either Single- or Multi-select)

data_type—STRING, NUMERIC, DATE, LIST, BLOB (binary large object), etc.

domain_values

domain_id—foreign key to response domains; part of primary key

selection_id—part of primary key

label—for lists, actual display value (e.g. “Yes”, “No”, “True”, etc.)

2. Dataset Storage—The following tables are used to store the actual data collected for a given occurrence of a dataset.

datasets

dataset_id—primary key

set_defn_id—foreign key to dataset_definitions

study_id—foreign key to studies

subject_id—foreign key to subjects

event_id—foreign key to events

date_collected—date of collection

title—used when added ad-hoc datasets, such as URL's and file uploads

dataset_type—SCHEDULED or APPENDED

completion_status—COMPLETE, INCOMPLETE, or NOT APPLICABLE

approval_status—APPROVED, NOT APPROVED, RETRACTED, NOT APPLICABLE

edit_reason—notes regarding reason for latest edit (if required)

approval_retraction_notes—notes regarding reason approval was retracted

data_items

data_item_id—primary key

dataset_id—foreign key to datasets

item_defn_id—foreign key to item_definitions

edit_reason—notes regarding why data item was edited (if required)

item_components

component_id—primary key

data_item_id—foreign key to data_items

comp_defn_id—foreign key to component_definitions

data_type—DATE, LIST, NUMBER, STRING, etc.

numeric_value—actual value, if numeric, stored here

string_value—actual value, if character string, stored here

blob_ptr—pointer to “binary large object” (up to 4 GB) stored here

clob_ptr—pointer to “character large object” (up to 4 GB) stored here

date_value—actual value, if date, stored here

3. Display of Datasets—The following tables are used to generate forms through which the user can access the datasets. Each display form relates to only one dataset definition, but one dataset definition could be displayed differently by multiple display forms.

display_forms

display_form_id—primary key

name—name used to identify this display form

description—description of this display form

set_defn_id—foreign key to dataset definitions

form_type—BROWSER, PDA, etc.

presentation_code—internal code used by UI

display_groups

display_group_id—primary key

display_form_id—foreign key to display_forms

group_sequence—sequence of group (1, 2, 3, . . . ) within this display form

group_name—used by study author for reference; not displayed to user

presentation_code—internal code used by UI (e.g. TABLE)

display_items

display_item_id—primary key

display_group_id—foreign key to display_groups

item_sequence—sequence of item (1, 2, 3, . . . ) within this display group

item_defn_id—foreign key to item_definitions

pre_label—text displayed just before data field

post_label—text (if any) displayed just after data field (e.g. “grams”)

presentation_code—internal code used by UI (e.g. RADIO, DROPDOWN, LIST)

4. Dataset Access Privileges—These tables allow access to be granted to roles, either at the dataset_definition or the data_item_definition level.

dataset_privileges

set_defn_id—foreign key to dataset_definitions; part of primary key

role_id—foreign key to roles; part of primary key

write_priv—1=updating data item enabled; 0=disabled

read_priv—1=viewing data item enabled; 0=disabled

delete_priv—1=deleting record enabled; 0=disabled

insert_priv—1=inserting new record enabled; 0=disabled

data_item_privileges

item_defn_id—foreign key to item_definitions; part of primary key

role_id—foreign key to roles; part of primary key

write_priv—1=updating data item enabled; 0=disabled

read_priv—1=viewing data item enabled; 0=disabled

5. Capabilities and Roles—These tables allow roles to be created for each study, and allow users to be given one or more roles, and for roles to be associated with one or more capabilities

roles

role_id—primary key

study_id—foreign key to studies

community_id—foreign key to communities

role_name—name of role

role_capabilities

role_id—foreign key to roles

capability_id—foreign key to capabilities

role_users

role_id—foreign key to roles

username—foreign key to users

date_assigned—date user was assigned this role

status—ACTIVE, INACTIVE

capabilities

capability_id—primary key

capability_name—name of capability (e.g. ‘Enroll Subjects’)

capability_type—this capability relevant to STUDY, COMMUNITY, or SYSTEM

6. Events—These tables are used to record the occurrence of events and to define what events are expected (i.e. scheduled) for a study.

events

event_id—primary key

title—name of event (e.g. ‘Initial Visit’, ‘1 Month Post-Op’)

study_id—foreign key to studies

subject_id—foreign key to subjects

scheduled_event_id—foreign key to scheduled_events

event_status—status: INCOMPLETE, APPROVED, COMPLETE

status_updated—date status was last changed

event_date—date/time of the event

entry_date—date/time the record was created

scheduled_events

scheduled_event_id—primary key

study_id—foreign key to studies

title—name of scheduled event (e.g. ‘Initial Visit’, ‘1 Month Post-Op’)

node_type—ORDERED, for sequential; NON-ORDERED for non-sequential

branch_type—AND, follow all outgoing paths; OR, choose outgoing path

description—used by study author for reference; not displayed to user

scheduled_event_links

parent_id—foreign key to scheduled_events (preceding event)

child_id—foreign key to scheduled_events (next event)

What is claimed is:

1. A clinical research data management system for a plurality of users comprising:
a computer system operable to service user requests and provide users with information responsive to the user requests, and
a database coupled to the computer system, wherein the database is operable to store user data and study data and wherein the study data includes candidate data, specimen data, event data and at least one dataset and wherein the dataset is defined using metadata.

2. The system of claim 1 wherein the database is operable to store data related to scheduled events and unscheduled events.

3. The system of claim 1 wherein the computer system is operable to send and receive electronic messages between at least two users.

4. The system of claim 3 wherein the computer system is operable to limit communication of electronic messages between users having a specific role in connection with a specific study.

5. The system of claim 1 wherein the candidate data includes data relating to a plurality of candidates and the specimen data includes data relating to a plurality of specimens wherein the system is operable to associate each specimen with a candidate.

6. The system of claim 1 wherein the user data includes at least one role associated with each user.

7. The system of claim 1 wherein the user data includes at least one role associated with each user, wherein the role is selected from the group of data monitor, enroller, data editor, study administrator and system administrator.

8. The system of claim 6 wherein the role defines data access rights granted at a dataset definition level.

9. The system of claim 6 wherein the role defines data access rights granted at a data item definition level.

10. The system of claim 6 wherein the role defines data access rights granted at a dataset definition level and data item definition level.

11. The system of claim 6 wherein the database is operable to identify at least a portion of the user data as privacy data and wherein the role defines a users ability to view privacy data.

12. The system of claim 1 wherein the database includes at least one display form associated with the dataset and wherein the display form is defined using metadata.

13. The system of claim 1 wherein the database includes at least two display forms associated with the dataset and wherein the display forms are defined using metadata.

14. The system of claim 13 wherein a first display form is formatted to render the dataset on a first display device, and a second display form is formatted to render the dataset on a second display device.

15. The system of claim 13 wherein a first display form is formatted to render the dataset in a first language, and a second display form is formatted to render the dataset in a second language.

16. The system of claim 1 wherein the database stores an audit record of data access including information relating to the data accessed, user, date and time.

17. The system of claim 1 wherein at least a portion of the user data or study data is stored in the database in an encrypted format.

18. A clinical research data management method for a plurality of users comprising:
storing user data and study data in a database coupled to a computer system, wherein the study data includes candidate data, specimen data, event data and at least one dataset and wherein the dataset is defined using metadata.

19. The method of claim 18 wherein the database is operable to store data related to scheduled events and unscheduled events.

20. The method of claim 18 wherein the computer system is operable to send and receive electronic messages between at least two users.

21. The method of claim 20 wherein the computer system is operable to limit communication of electronic messages between users having a specific role in connection with a specific study.

22. The method of claim 18 wherein the candidate data includes data relating to a plurality of candidates and the specimen data includes data relating to a plurality of specimens wherein the system is operable to associate each specimen with a candidate.

23. The method of claim 18 wherein the user data includes at least one role associated with each user.

24. The method of claim 18 wherein the user data includes at least one role associated with each user, wherein the role is selected from the group of data monitor, enroller, data editor, study administrator and system administrator.

25. The method of claim 23 wherein the role defines data access rights granted at a dataset definition level.

26. The method of claim 23 wherein the role defines data access rights granted at a data item definition level.

27. The method of claim 23 wherein the role defines data access rights granted at a dataset definition level and data item definition level.

28. The method of claim 23 wherein the database is operable to identify at least a portion of the user data as privacy data and wherein the role defines a users ability to view privacy data.

29. The method of claim 18 wherein the database includes at least one display form associated with the dataset and wherein the display form is defined using metadata.

30. The method of claim 18 wherein the database includes at least two display forms associated with the dataset and wherein the display forms are defined using metadata.

31. The method of claim 18 wherein a first display form is formatted to render the dataset on a first display device, and a second display form is formatted to render the dataset on a second display device.

32. The method of claim 18 wherein a first display form is formatted to render the dataset in a first language, and a second display form is formatted to render the dataset in a second language.

33. The method of claim 18 wherein the database stores an audit record of data access including information relating to the data accessed, user, date and time.

34. A clinical research data management system for a plurality of users comprising:
a computer system operable to service user requests and provide users with information responsive to the user requests, and
a database coupled to the computer system, wherein the database is operable to store user data and study data relating to a plurality of studies, wherein study data includes candidate data, specimen data, event data and at least one dataset, wherein user data includes at least one role associated with each user and wherein the role defines data access rights granted at one of a dataset definition level and data item definition level.

35. A clinical research data management system for a plurality of users comprising:
a computer system operable to service user requests and provide users with information responsive to the user requests, and
a database coupled to the computer system, wherein the database is operable to store user data and study data relating to a plurality of studies, wherein study data includes candidate data, specimen data, event data and at least one dataset, wherein user data includes at least one role associated with each user and wherein the computer system is operable to limit communication of electronic messages between user having a specific role in connection with a specific study.

36. A clinical research data management system for a plurality of users comprising:
a means for servicing user requests and providing users with information responsive to the user requests, and
a database for storing user data and study data and wherein the study data includes candidate data, specimen data, event data and at least one dataset and wherein the dataset is defined using metadata.

37. A clinical research data management system for administering a plurality of studies, the system having a computer system operable to service user requests and provide users with information responsive to the user requests and a database with a flexible database structure that facilitates the study definition process for a broad range of studies, the system comprising:
(a) presentation creation means operable to provide users with dynamic information,
(b) application control and navigation means operable to service user requests,
(c) data access means operable to access information that resides in a system database wherein the database is operable to store user data and study data and wherein the study data includes candidate data, specimen data, event data and at least one dataset and wherein the dataset is defined using metadata.

38. The system of claim 37 further comprising:
(d) application and data security means operable to limit users access to information in the system database.
